(19) United States
(12) Patent Application Publication
(10) Pub. No.: US 2026/0213904 A1
(43) Pub. Date: Jul. 23, 2026

(54) PHASE TRACKING REFERENCE SIGNAL MAPPING FOR PUSCH TRANSMISSION

(71) Applicant: SHARP KABUSHIKI KAISHA, Sakai City (JP)

(72) Inventor: TOMOKI YOSHIMURA, Camas, WA (US)

(21) Appl. No.: 19/035,402

(22) Filed: Jan. 23, 2025

(51) Int. Cl. H04L 5/00; H04L 5/14

(52) U.S. Cl. CPC H04L 5/0051; H04L 5/14

(57) ABSTRACT

A user equipment (UE), receives, from a base station (BS), a message for scheduling a physical uplink (UL) shared channel (PUSCH) transmission, the message indicating a first UL bandwidth comprising a first group of resource blocks (RBs). The UE determines a second UL bandwidth that includes a second group of RBs that is derived from an intersection of the first group of RBs and a group of RBs associated with a UL subband full duplex (SBFD). The second groups of RBs includes fewer RBs than the first group of RBs. The UE maps several phase-tracking reference signals (PT-RSs), associated with the PUSCH, to the second group of RBs. The UE transmits, to the BS, the PUSCH that includes the mapped PT-RSs.

### TECHNICAL FIELD

The technology generally relates to wireless communications, and more particularly to the mapping of Phase Tracking Reference Signal (PT-RS) and the mapping of the Uplink Control Information (UCI) coded modulation symbols for Physical Uplink Shared Channel (PUSCH) transmission.

### BACKGROUND

Because of the tremendous growth in the number of connected devices and the rapid increase in the user/network (NW) traffic volume, various efforts have been made to improve different aspects of the wireless communications in the next-generation radio communication systems, such as the 5^{th} generation (5G) New Radio (NR). Such improvements include improving data rate, latency, reliability, mobility, etc.

The 5G NR system is designed to provide flexibility and configurability to optimize NW services and types, thus accommodating various use cases, such as enhanced Mobile Broadband (eMBB), massive Machine-Type Communication (mMTC), and Ultra-Reliable and Low-Latency Communication (URLLC).

As the demand for radio access continues to grow, however, there is a need for further improvements in wireless communications in the next-generation radio communication systems.

### SUMMARY

In a first aspect of the present application a user equipment (UE) is provided. The UE includes one or more non-transitory computer-readable media that store one or more computer-executable instructions. The UE includes at least one processor that is coupled to the one or more non-transitory computer-readable media, and configured to execute the one or more computer-executable instructions to cause the UE to receive, from a base station (BS), a message for scheduling a PUSCH transmission, the message indicating a first UL bandwidth that includes a first group of resource blocks (RBs); determine a second UL bandwidth that includes a second group of RBs that is derived from an intersection of the first group of RBs and several RBs associated with a UL subband full duplex (SBFD), where the second group of RBs includes fewer RBs than the first group of RBs; map several PT-RSs, associated with the PUSCH, to the second group of RBs; and transmit, to the BS, the PUSCH that includes the mapped PT-RSs.

In an implementation of the first aspect, the PT-RSs include several PT-RS groups, each PT-RS group includes several PT-RS samples, each RB includes several subcarriers in frequency domain. The mapping the PT-RSs to the second group of RBs includes receiving, from the BS, a number of PT-RS groups and a number of samples per PT-RS group, determining several subcarrier indexes based on the number of PT-RS groups and the number of samples per PT-RS group, and mapping the PT-RSs to the second group of RBs starting at the determined subcarrier indexes.

In another implementation of the first aspect, the subcarrier indexes are determined as a function of a total number of subcarriers in the second UL bandwidth.

In another implementation of the first aspect, the number of PT-RS groups and the number of samples per PT-RS group are received, from the BS, in radio resource control (RRC) signaling.

In another implementation of the first aspect, the message received from the BS includes downlink control information (DCI), and the first UL bandwidth is indicated by a frequency domain resource allocation (FDRA) field in the DCI.

In another implementation of the first aspect, the FDRA field includes several bits, each bit indicates whether a corresponding RB group is allocated for the PUSCH, and each RB group includes several RBs.

In another implementation of the first aspect, the DCI is received, from the BS, in a physical downlink control channel (PDCCH).

In a second aspect of the present application a UE is provided. The UE includes one or more non-transitory computer-readable media that store one or more computer-executable instructions. The UE includes at least one processor that is coupled to the one or more non-transitory computer-readable media, and configured to execute the one or more computer-executable instructions to cause the UE to receive, from a BS, a message for scheduling a PUSCH transmission, the message indicating a first UL bandwidth that includes first group of RBs; determine a second UL bandwidth that includes a second group of RBs that is derived from an intersection of the first group of RBs and several RBs associated with a UL SBFD, where the second group of RBs includes fewer RBs than the first group of RBs; map several UCI coded modulation symbols, associated with the PUSCH, to an RB in the second group of RBs; and transmit, to the BS, the PUSCH that includes the mapped UCI coded modulation symbols.

In an implementation of the second aspect, the UCI coded modulation symbols include several hybrid automatic repeat request acknowledgement (HARQ-ACK) coded modulation symbols.

In another implementation of the second aspect, each RB includes several of OFDM symbols, each OFDM symbol includes several resource elements (REs). The mapping the UCI coded modulation symbols to the RB in the second group of RBs includes: mapping several demodulation reference signal (DMRS) symbols, arranged in a frequency-first time-second sequence, to the REs of several OFDM symbols of the RB, identifying an OFDM symbol that is after a first DMRS symbol in the frequency-first time-second sequence, and starting with the identified OFDM, mapping the HARQ-ACK coded modulation symbols, arranged in the frequency-first time-second sequence, to several REs.

In another implementation of the second aspect, the UCI coded modulation symbols include several channel state information (CSI) part 1 coded modulation symbols, and several CSI part 2 coded modulation symbols.

In another implementation of the second aspect, each RB includes several OFDM symbols, each OFDM symbol includes several resource elements (REs). The mapping the UCI coded modulation symbols to the RB in the second group of RBs includes: starting with a first OFDM symbol in the RB, mapping the CSI part 1 coded modulation symbols, arranged in a frequency-first time-second sequence, to several REs, and starting with the first OFDM symbol in the RB, mapping the CSI part 2 coded modulation symbols, arranged in a frequency-first time-second sequence, to several REs that is not mapped to the CSI part 1 coded modulation symbols.

In another implementation of the second aspect, the message received from the BS includes DCI, the first UL bandwidth is indicated by an FDRA field in the DCI, and the DCI is received from the BS in a PDCCH.

In another implementation of the second aspect, the FDRA field includes several bits, each bit indicates whether a corresponding RB group is allocated for the PUSCH, and each RB group includes several RBs.

In a third aspect of the present application, a method is provided. The method includes receiving, by a UE, from a BS, a message for scheduling a PUSCH transmission, the message indicating a first UL bandwidth that includes a first group of RBs; determining a second UL bandwidth that includes a second group of RBs that is derived from an intersection of the first group of RBs and several RBs associated with a SBFD, where the second group of RBs includes fewer RBs than the first group of RBs; mapping several PT-RSs, associated with the PUSCH, to the second group of RBs; and transmitting, to the BS, the PUSCH that includes the mapped PT-RSs.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a schematic diagram illustrating a radio communication system, according to an example implementation of the present disclosure.

FIGS. 2A and 2B are two diagrams illustrating parameters related to subcarrier spacing (SCS)-specific carriers, according to an example implementation of the present disclosure.

FIG. 3 is a diagram illustrating an example configuration of SCS-specific carriers, according to an example implementation of the present disclosure.

FIG. 4 is a diagrammatic view illustrating an example configuration of a resource grid, according to an example implementation and mode of the present disclosure.

FIG. 5 is a schematic block diagram illustrating a configuration example of a base station device, according to an example implementation of the present disclosure.

FIG. 6 is a schematic block diagram illustrating a configuration example of a terminal device, according to an example implementation of the present disclosure.

FIG. 7 is a diagram illustrating an example configuration of a synchronization signal/physical broadcast channel (SS/PBCH) block including a primary synchronization signal (PSS) and a secondary synchronization signal (SSS), according to an example implementation of the present disclosure.

FIG. 8 is a time-frequency diagram illustrating an example resource partitioning in a serving cell, according to an example implementation of the present disclosure.

FIG. 9 is a time domain diagram illustrating an example resource definition in a serving cell, according to an example implementation of the present disclosure.

FIG. 10 is a diagram illustrating PT-RS mapping when transform precoding is enabled, according to an example implementation of the present disclosure.

FIG. 11 is a diagram illustrating an example of scheduling RBs in the UL subband, according to prior art.

FIG. 12 is a diagram illustrating an example of PT-RS mapping enhancement, according to an example implementation of the present disclosure.

FIG. 13 illustrates a table that includes an example PT-RS group pattern as a function of the scheduled bandwidth, according to an example implementation of the present disclosure.

FIG. 14 illustrates a table that includes an example relationship between the parameters

$${N}_{samp}^{group} , {N}_{group}^{PT - RS} ,$$

and the PT-RS allocation index m, according to an example implementation of the present disclosure.

FIG. 15 illustrates a table that includes an example relationship between the parameters

$${N}_{samp , SBFD}^{group} , {N}_{group , SBFD}^{PT - RS} ,$$

and the PT-RS allocation index m, according to an example implementation of the present disclosure.

FIG. 16 is a flowchart illustrating an example method/process performed by a UE to map PT-RS to REs, according to an example implementation of the present disclosure.

FIG. 17 is a diagram illustrating the UL-SCH data sequence mapping to REs in frequency-first time-second manner, according to an example implementation of the present disclosure.

FIG. 18 is a diagram illustrating multiplexing of UL-SCH and HARQ-ACK, according to an example implementation of the present disclosure.

FIG. 19 is a diagram illustrating multiplexing of the UL-SCH and CSI, according to an example implementation of the present disclosure.

FIG. 20 is a diagram illustrating PUSCH scheduling in SBFD symbols when a scheduled RB is invalidated due to being outside of the UL subband, according to prior art.

FIG. 21 is a diagram illustrating a solution which avoids the dropping of PT-RS and HARQ-ACK, when the PUSCH is scheduled in the UL subband, according to an example implementation of the present disclosure.

FIG. 22 is a diagram illustrating a solution which avoids the dropping of PT-RS, CSI part 1, and CSI part 2, when the PUSCH is scheduled in the UL subband, according to an example implementation of the present disclosure.

FIG. 23 is a flowchart illustrating an example method/process performed by a UE to map UCI symbols to REs, according to an example implementation of the present disclosure.

### DETAILED DESCRIPTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not shown) by the same numerals in the example figures. However, the features in different implementations may differ in other respects, and thus may not be narrowly confined to what is shown in the figures.

The description uses the phrases “in one implementation,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent. In addition, the terms “system” and “network” herein may be used interchangeably.

As used herein, the term “and/or” should be interpreted to mean one or more items. For example, the phrase “A, B, and/or C” should be interpreted to mean any of: only A, only B, only C, A and B (but not C), B and C (but not A), A and C (but not B), or all of A, B, and C. As used herein, the phrase “at least one of” should be interpreted to mean one or more items. For example, the phrase “at least one of A, B, and C” or the phrase “at least one of A, B, or C” should be interpreted to mean any of: only A, only B, only C, A and B (but not C), B and C (but not A), A and C (but not B), or all of A, B, and C. As used herein, the phrase “one or more of” should be interpreted to mean one or more items. For example, the phrase “one or more of A, B and C” or the phrase “one or more of A, B or C” should be interpreted to mean any of: only A, only B, only C, A and B (but not C), B and C (but not A), A and C (but not B), or all of A, B, and C.

Any two or more of the following paragraphs, (sub)-bullets, points, actions, behaviors, terms, or claims described in the present disclosure may be combined logically, reasonably, and properly to form a specific method.

Any sentence, paragraph, (sub)-bullet, point, action, behaviors, terms, or claims described in the present disclosure may be implemented independently and separately to form a specific method.

Dependency, e.g., “based on”, “more specifically”, “preferably”, “in one embodiment”, “in some implementations”, etc., in the present disclosure is just one possible example which would not restrict the specific method.

Additionally, for the purposes of explanation and non-limitation, specific details, such as functional entities, techniques, protocols, standard, and the like are set forth for providing an understanding of the described technology. In other examples, detailed descriptions of well-known methods, technologies, systems, architectures, and the like are omitted so as not to obscure the description with unnecessary details.

Persons skilled in the art will immediately recognize that any network function(s) or algorithm(s) described in the present disclosure may be implemented by hardware, software, or a combination of software and hardware. Described functions or algorithms may correspond to modules which may be software, hardware, firmware, or any combination thereof. The software implementation may include computer executable instructions stored on a computer-readable medium, such as a memory or other types of storage devices. For example, one or more microprocessors or general-purpose computers with communication processing capability may be programmed with corresponding executable instructions and carry out the described network function(s) or algorithm(s). The microprocessors or general-purpose computers may include of one or more Application-Specific Integrated Circuits (ASICs), programmable logic arrays, and/or one or more Digital Signal Processor (DSPs). Although some of the example implementations described in this specification are oriented to software installed and executing on computer hardware, nevertheless, alternative example implementations implemented as firmware, as hardware, or as a combination of hardware and software are well within the scope of the present disclosure.

The computer-readable medium includes, but is not limited to, Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture (e.g., a Long-Term Evolution (LTE) system, an LTE-Advanced (LTE-A) system, an LTE-Advanced Pro system, or a 5G NR Radio Access Network (RAN)) typically includes at least one base station (BS), at least one UE, and one or more optional network elements that provide connection towards a network. The UE communicates with the network (e.g., a Core Network (CN), an Evolved Packet Core (EPC) network, an Evolved Universal Terrestrial Radio Access network (E-UTRAN), a 5G Core (5GC), or an internet), through a radio communication network established by one or more BSs.

It should be noted that, in the present disclosure, a UE (or a terminal device) may include, but is not limited to, a mobile station, a mobile terminal or device, a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access network.

A BS may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GPRS), Universal Mobile Telecommunication System (UMTS, often referred to as 3G) based on basic wideband-code division multiple access (W-CDMA), high-speed packet access (HSPA), LTE, LTE-A, evolved LTE (eLTE), for example, LTE connected to 5GC, NR (often referred to as 5G), LTE-A Pro, and/or a new radio system referred to as 6G. However, the scope of the present disclosure should not be limited to the above-mentioned protocols.

A BS may include, but is not limited to, a node B (NB) as in the UMTS, an evolved node B (eNB) as in the LTE or LTE-A, a radio network controller (RNC) as in the UMTS, a base station controller (BSC) as in the GSM/GSM Enhanced Data rates for GSM Evolution (EDGE) Radio Access Network (GERAN), a next-generation eNB (ng-eNB) as in an Evolved Universal Terrestrial Radio Access (E-UTRA) BS in connection with the 5GC, a next-generation Node B (gNB) as in the 5G Access Network (5G-AN), a 6G Node B (6gNB) and any other apparatus capable of controlling radio communication and managing radio resources within a cell. The BS may connect to serve the one or more UEs through a radio interface to the network.

The BS may be operable to provide radio coverage to a specific geographical area using one or more cells included in the radio communication network. The BS may support the operations of the cells. Each cell may be operable to provide services to at least one UE within its radio coverage. Specifically, each cell (often referred to as a serving cell) may provide services to serve one or more UEs within its radio coverage (e.g., each cell may correspond to the Downlink (DL) and optionally Uplink (UL) resources to at least one UE within its radio coverage for DL and optionally UL packet transmission). The BS may communicate with one or more UEs in the radio communication system through the cells.

A cell may correspond to sidelink (SL) resources for supporting Proximity Service (ProSe) or Vehicle to Everything (V2X) services. Each cell may have overlapped coverage areas with other cells.

As discussed above, the frame structure for NR or 6G is to support flexible configurations for accommodating various next generation communication requirements, such as Enhanced Mobile Broadband (eMBB), Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in the 3^{rd} Generation Partnership Project (3GPP) may serve as a baseline for NR or 6G waveform. The scalable OFDM numerology, such as the adaptive sub-carrier spacing, the channel bandwidth, and the Cyclic Prefix (CP) may also be used. Additionally, two coding schemes are considered for NR or 6G: (1) Low-Density Parity-Check (LDPC) code and (2) Polar Code. The coding scheme adaption may be configured based on the channel conditions and/or the service applications.

Moreover, it should also be noted that in a transmission time interval of a single NR or 6G frame, a DL transmission period, a guard period, and UL transmission data may at least be included, where the respective portions of the DL transmission data, the guard period, and the UL transmission data should also be configurable, for example, based on the network dynamics of NR or 6G. In addition, sidelink resources may also be provided in an NR or 6G frame to support ProSe services, (E-UTRA/NR) sidelink services, or (E-UTRA/NR) V2X services.

A UE configured with multi-connectivity may connect to a Master Node (MN) as an anchor and one or more Secondary Nodes (SNs) for data delivery. Each one of these nodes may be formed by a cell group that includes one or more cells. For example, a Master Cell Group (MCG) may be formed by an MN, and a Secondary Cell Group (SCG) may be formed by an SN. In other words, for a UE configured with dual connectivity (DC), the MCG may be a set of one or more serving cells including the PCell and zero or more secondary cells. Conversely, the SCG may be a set of one or more serving cells including the PSCell and zero or more secondary cells.

As also described above, the Primary Cell (PCell) may be an MCG cell that operates on the primary frequency, in which the UE either performs the initial connection establishment procedure or initiates the connection reestablishment procedure. In the DC mode, the PCell may belong to the MN. The Primary SCG Cell (PSCell) may be an SCG cell in which the UE performs random access (e.g., when performing the reconfiguration with a sync procedure). In Multi-RAT Dual Connectivity (MR-DC), the PSCell may belong to the SN. A Special Cell (SpCell) may be referred to a PCell of the MCG, or a PSCell of the SCG, depending on whether the Medium Access Control (MAC) entity is associated with the MCG or the SCG. Otherwise, the term Special Cell may refer to the PCell. A Special Cell may support a Physical Uplink Control Channel (PUCCH) transmission and contention-based Random Access, and may always be activated. Additionally, for a UE in a radio resource control connected (RRC_CONNECTED) state that is not configured with the carrier aggregation/dual connectivity (CA/DC), may communicate with only one serving cell (SCell) which may be the primary cell. Conversely, for a UE in the RRC_CONNECTED state that is configured with the CA/DC a set of serving cells including the special cell(s) and all of the secondary cells may communicate with the UE.

Some mathematical expressions used in the present application are provided below.

Floor (CX) represents a floor function for the real number CX. For example, floor (CX) may represent a function that provides the largest integer within a range that does not exceed the real number CX.

Ceil (DX) represents a ceiling function to a real number DX. For example, ceil (DX) may be a function that provides the smallest integer within the range not less than the real number DX.

Mod (EX, FX) represents a function that provides the remainder obtained by dividing EX by FX.

Exp (GX) represents e \hat{ } GX. Here, e is the Napier number. Also, (HX) \hat{ } (IX) indicates IX to the power of HX.

According to one aspect of the present disclosure, a waveform formed based on the OFDM may be used in a radio communication system. An OFDM symbol defines a unit in the time domain of the waveform. Each OFDM symbol is converted to a time-continuous signal during a baseband signal generation. For example, the cyclic prefix-OFDM (CP-OFDM) may be used in the downlink transmission of the radio communication system. For example, either CP-OFDM or Discrete Fourier Transform-spread-Orthogonal Frequency Division Multiplex (DFT-s-OFDM) may be used in the uplink transmission of the radio communication system.

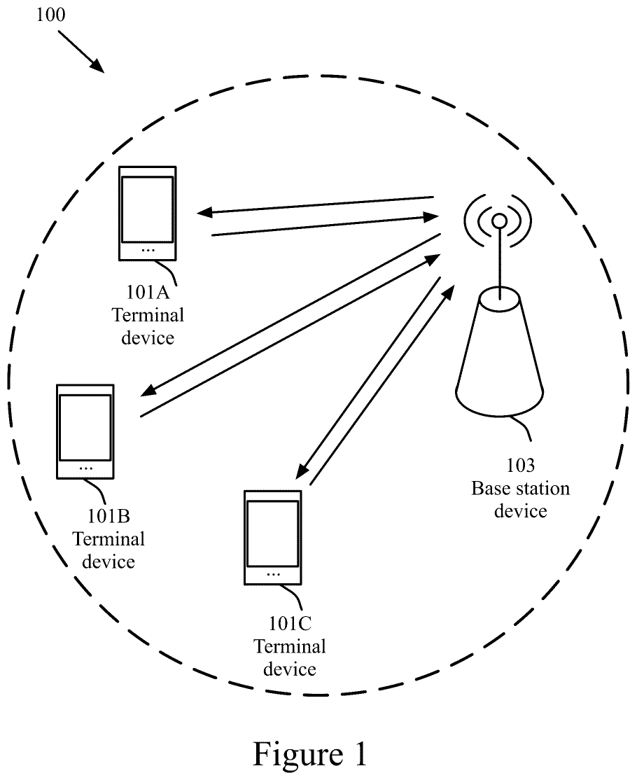

FIG. 1 is a schematic diagram illustrating a radio communication system, according to an example implementation of the present disclosure. In FIG. 1, the radio communication system 100 includes the terminal devices 101A to 101C and the base station device 103 (BS 103). The terms base station device, base station, and BS herein may be used interchangeably. The terms terminal device, user equipment, and UE herein may be used interchangeably.

The BS 103 may include one or more transmission/reception devices. When the BS 103 is configured with multiple transmission/reception devices, each of the multiple transmission/reception devices may be arranged at a different position. A transmission/reception device may include a transmission device and/or a reception device.

The BS 103 may serve radio communication and provide one or more cells. A cell is defined in this disclosure as a set of resources used for a wireless communication. A cell may include one or both of a downlink component carrier and an uplink component carrier. A serving cell may include a downlink component carrier and two or more uplink component carriers.

One or more SubCarrier Spacing-specific (SCS-specific) carriers may be associated with one component carrier. Each SCS-specific carrier defines a carrier for a subcarrier-spacing configuration. For example, one SCS-specific carrier may be associated with either a downlink component carrier or an uplink component carrier. In another example, one SCS-specific carrier may be associated with both a downlink component carrier and an uplink component carrier.

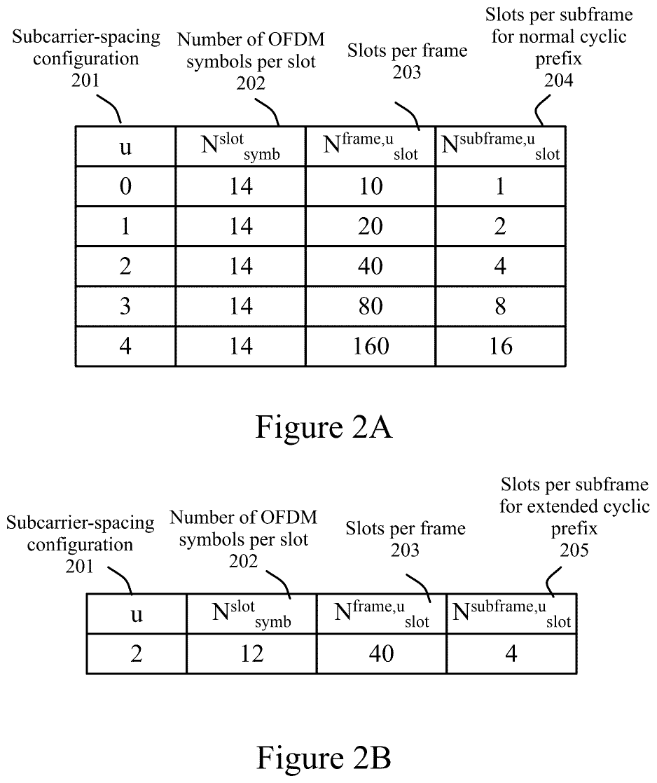

FIGS. 2A and 2B are two diagrams illustrating parameters related to SCS-specific carriers, according to an example implementation of the present disclosure. In FIGS. 2A and 2B, u 201 represents the subcarrier-spacing configuration. N^{slot}_{symb} 202 represents the number of OFDM symbols in a slot. N^{frame, u}ₛₗₒₜ 203 represents the number of slots in a radio frame. N^{subframe, u}ₛₗₒₜ 204 and N^{subframe, u}ₛₗₒₜ 205 represent the number of slots in a subframe for normal cyclic prefix and extended cyclic prefix, respectively.

In 6G radio, a new time unit may be introduced. The new time unit N^{new-unit}_{symb} may for example be a multiple of 14.

In FIG. 2A, for example, when the subcarrier-spacing configuration u 201 is set to 2 and the CP configuration is set to normal Cyclic Prefix CP), the parameters are set to N^{slot}_{symb}=14, N^{frame, u}ₛₗₒₜ=40, and N^{subframe, u}ₛₗₒₜ=4. Further, in FIG. 2B, for example, when the subcarrier-spacing configuration u 201 is set to 2 and the CP configuration is set to an extended CP, the parameters are set to N^{slot}_{symb}=12, N^{frame, u}ₛₗₒₜ=40, N^{subframe, u}ₛₗₒₜ=4.

Value range of N^{new-unit}_{symb} may be different in respective subcarrier-spacing configuration u. For example, the value range of N^{new-unit}_{symb} may be 1 and 2 for u=0, 1, 2, 3, and 4 for u=1, 1, 2, 4, 8, and 16 for u=2.

The time unit T_{c} represents the length of the time domain. The time unit T_{c} may be calculated by 1/(dfₘₐₓ*N_{f}), where dfₘₐₓ represents 480 kHz and N_{f}=4096. The constant k may be calculated by dfₘₐₓ*N_{f}/(df_{ref}N_{f, ref}). The constant k is 64 when df_{ref} is 15 kHz and N_{f, ref} is 2048.

In 6G radio, N_{f} may be equal to or larger than 4096. For example, N_{f} may be 8192 or 16384.

Radio transmissions in the downlink and/or radio transmissions in the uplink may be organized into radio frames (or system frames, frames) of length T_{f}. T_{f} is calculated by (dfₘₐₓN_{f}/100)*Tₛ and (dfₘₐₓN_{f}/100)*Tₛ is equal to 10 ms. One radio frame may include ten subframes. The subframe length T_{sf} is calculated by dfₘₐₓN_{f}Tₛ/1000 and dfₘₐₓN_{f}Tₛ/1000 is equal to 1 ms. The number of OFDM symbols per subframe N^{subframe, u}_{symb} is calculated by N^{slot}_{symb}N^{subframe, u}ₛₗₒₜ.

The SCS of the OFDM-based waveform may be calculated by subcarrier-spacing configuration u. For example, the SCS may be calculated by 15000*2^{u}.

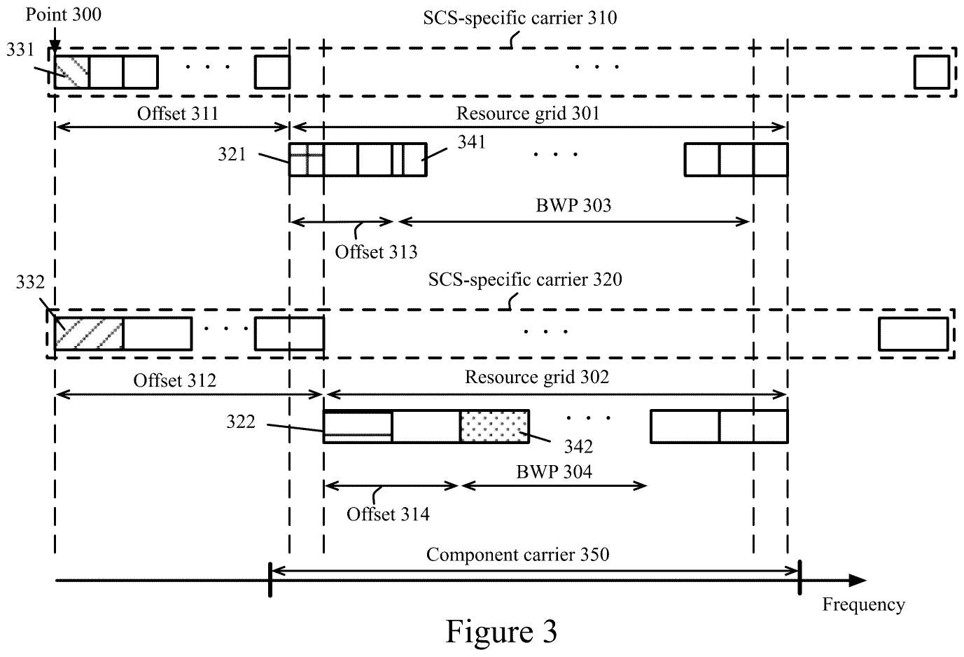

FIG. 3 is a diagram illustrating an example configuration of SCS-specific carriers, according to an example implementation of the present disclosure. The horizontal axis in FIG. 3 represents the frequency domain. FIG. 3 shows a configuration example of two SCS-specific carriers associated with the component carrier 350. In FIG. 3, u₁=u₂−1 is assumed.

Point 300 is an identifier for a specific subcarrier. Point 300 is also referred to as Point A. Common resource blocks (CRBs) for SCS-specific carrier 310 are defined with respect to Point 300. The CRB with index 0 is represented by the block 331. CRBs for SCS-specific carrier 320 are defined with respect to Point 300. The CRB with index 0 is represented by the block 332. The CRB with index 0 is defined as the CRB where a subcarrier in the CRB coincides with the subcarrier identified by Point 300.

In FIG. 3, the bandwidth of one CRB in the SCS-specific carrier 310 is a half bandwidth of one CRB in the SCS-specific carrier 320. In other implementations, the bandwidth of one CRB in the SCS-specific carrier 310 may be the same as the bandwidth of one CRB in the SCS-specific carrier 320.

The offset 311 is a Resource Block-level (RB-level) offset from the CRB with index 0 for SCS-specific carrier 310 to the reference point 321 of the resource grid 301. The reference point of the resource grid 301 is the block 321. The offset 312 is an RB-level offset from the CRB with index 0 for SCS-specific carrier 320 to the reference point 322 of the resource grid 302. The reference point of the resource grid 302 is the block 322.

The offset 313 is an RB-level offset from the reference point 321 of the resource grid 301 to the reference point 341 of the Band Width Part (BWP) 303. The reference point of the BWP 303 is the block 341. The offset 314 is an RB-level offset from the reference point 322 of the resource grid 301 to the reference point 342 of the BWP 304. The reference point of the BWP 304 is the block 342.

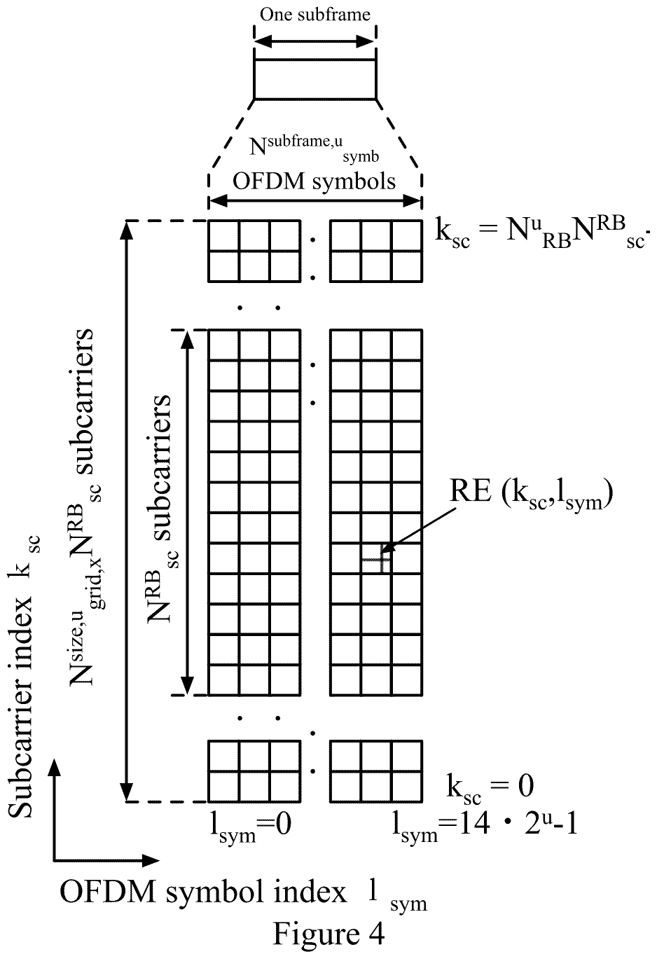

FIG. 4 is a diagrammatic view illustrating an example configuration of a resource grid, according to an example implementation and mode of the present disclosure. The horizontal axis represents OFDM symbol index l_{sym}. The vertical axis represents the subcarrier index k_{sc}. The resource grid includes N^{size,u}_{grid,x}N^{RB}_{sc} subcarriers and N^{subframes,u}_{symb} OFDM symbols. A resource specified by the subcarrier index k_{sc} and the OFDM symbol index l_{sym} in a resource grid is also referred to as Resource Element (RE).

A resource block (RB) includes N^{RB}_{sc} consecutive subcarriers. A resource block is a generic name for a CRB, a Physical Resource Block (PRB), and/or a Virtual Resource Block (VRB). In FIG. 4, N^{RB}_{sc} may be 12. CRBs are indexed in ascending order starting at CRB with index 0. PRBs are indexed in ascending order starting at its reference point of the BWP. A BWP is defined as a subset of resource blocks included in the resource grid. The BWP includes N^{size}, u_{BWP,i} resource blocks starting from the reference points of the BWP.

An antenna port may be defined such that the channel over which a symbol on the antenna port is conveyed may be inferred from the channel over which another symbol on the same antenna port is conveyed. The channel may correspond to a physical channel. The symbols may correspond to OFDM symbols. The symbols may correspond to resource block units. The symbols may correspond to resource elements.

Two antenna ports are said to be Quasi Co-Located (QCL) if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters. Carrier aggregation is a framework of communication using multiple aggregated serving cells or using multiple component carriers.

The new time unit may be a time unit in which the transmitter assumes that the receiver may combine received Demodulation Reference Signal (DMRS) symbols in the new time unit. By combining the DMRS symbols in the new time unit, the receiver may perform channel estimation. For example, the transmitter may determine to maintain phase continuity and/or power consistency in the new time unit.

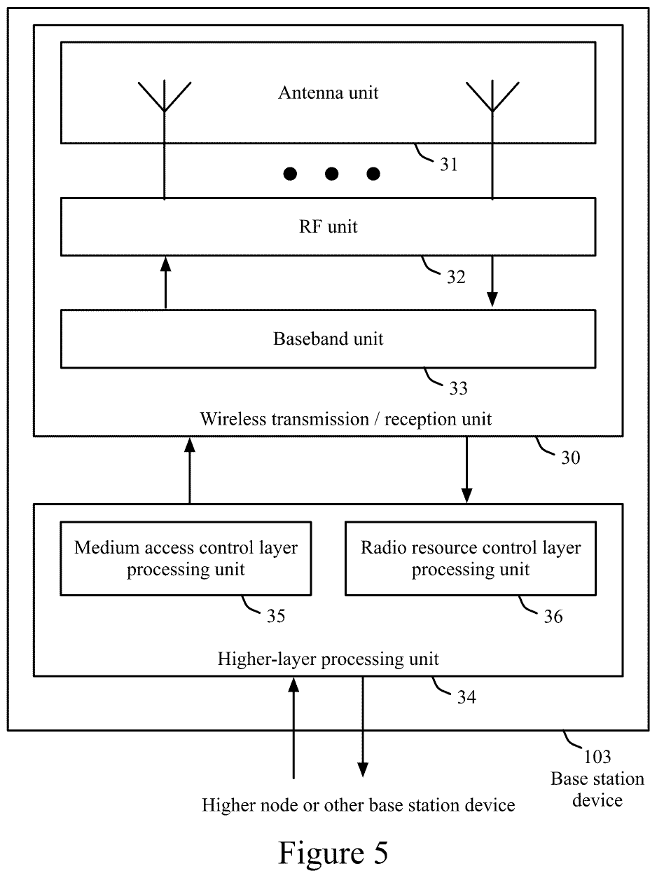

FIG. 5 is a schematic block diagram illustrating a configuration example of a base station device 103, according to an example implementation of the present disclosure. As shown in FIG. 5, the base station device 103 may include a part or all of the wireless transmission and reception unit (also referred to herein as physical layer processing unit) 30 and a higher-layer processing unit 34. The wireless transmission and reception unit 30 may include a part or all of an antenna unit 31, a Radio Frequency (RF) unit 32, and a baseband unit 33. The higher-layer processing unit 34 may include a part or all of a Medium Access Control (MAC) layer processing unit 35 and a Radio Resource Control (RRC) layer processing unit 36.

The wireless transmission and reception unit 30 may include a part (or all) of a wireless transmission unit 30a (not shown in the figure) and a wireless reception unit 30b (not shown in the figure). The configuration of the baseband unit 33 in the wireless transmission unit 30a and the configuration of the baseband unit 33 in the wireless reception unit 30b may be the same or different. The configuration of the RF unit 32 in the wireless transmission unit 30a and the configuration of the RF unit 32 in the wireless reception unit 30b may be the same or different. The configuration of the antenna unit 31 in the wireless transmission unit 30a and the configuration of the antenna unit 31 in the wireless reception unit 30b may be the same or different. The wireless transmission and reception unit 30 may include at least one processor (not shown in the figure) and one or more non-transitory computer-readable media (not shown in the figure) that store computer-executable instructions and data.

The higher-layer processing unit 34 may provide downlink data (e.g., transport blocks) to the wireless transmission and reception unit 30 (or the wireless transmission unit 30a). The higher-layer processing unit 34 may perform the processing of a part or all of the MAC layer, the Packet Data Convergence Protocol (PDCP) layer, the Radio Link Control (RLC) layer and the RRC layer. The higher-layer processing unit 34 may also include at least one processor (not shown in the figure) and one or more non-transitory computer-readable media (not shown in the figure) that store computer-executable instructions and data.

The MAC layer processing unit 35 may perform the processing of the MAC layer. The RRC layer processing unit 36 may perform the processing of the RRC layer. The RRC layer processing unit 36 may manage various RRC parameters of the terminal device 101.

The wireless transmission and reception unit 30 (or the wireless transmission unit 30a) may perform processing, such as encoding and modulation. The wireless transmission and reception unit 30 (or the wireless transmission unit 30a) generates a physical signal by encoding and modulating the downlink data. The wireless transmission and reception unit 30 (or the wireless transmission unit 30a) converts the OFDM symbols in the physical signal to a baseband signal by converting them to a time-continuous signal. The wireless transmission and reception unit 30 (or the wireless transmission unit 30a) transmits the baseband signal (or the physical signal) to the terminal device 101 via radio frequency. The wireless transmission and reception unit 30 (or the wireless transmission unit 30a) may arrange the baseband signal (or the physical signal) on a component carrier and transmit the baseband signal (or the physical signal) to the terminal device 101.

The wireless transmission and reception unit 30 (or the wireless reception unit 30b) may perform processing, such as demodulation and decoding. The wireless transmission and reception unit 30 (or the wireless reception unit 30b) separates, demodulates, and decodes the received physical signal, and provides the decoded information to the higher-layer processing unit 34. The wireless transmission and reception unit 30 (or the wireless reception unit 30b) may perform the channel access procedure prior to the transmission of the physical signal.

The RF unit 32 demodulates the radio signal received via the antenna unit 31 into an analog signal, and/or removes the extra frequency components. The RF unit 32 provides the processed analog signal to the baseband unit 33.

The baseband unit 33 converts the analog signal input from the RF unit 32 into a baseband signal. The baseband unit 33 separates a portion which corresponds to the CP from the baseband signal. The baseband unit 33 performs Fast Fourier Transformation (FFT) on the baseband signal from which the CP has been removed. The baseband unit 33 extracts components of the physical signal from the baseband signal. The baseband unit 33 performs Inverse Fast Fourier Transformation (IFFT) on the downlink data to generate time-continuous signal, adds a CP to the generated signal, generates a baseband signal, and converts the baseband signal into an analog signal. The baseband unit 33 provides the analog signal to the RF unit 32.

The RF unit 32 removes the extra frequency components from the analog signal input from the baseband unit 33, up-converts the analog signal to a radio frequency, and transmits it via the antenna unit 31. The RF unit 32 may have the function of controlling transmission power.

The terminal device 101 may configure one or more downlink BWPs per serving cell. The terminal device 101 may configure one or more uplink BWPs per serving cell.

The terminal device 101 may try to detect a Physical Downlink Shared Channel (PDSCH), a Physical Downlink Control Channel (PDCCH), and a Channel State Information-Reference Signal (CSI-RS) in the active downlink BWP. The terminal device 101 may transmit a Physical Uplink Control Channel (PUCCH) and a Physical Uplink Shared Channel (PUSCH) in the active uplink BWP. The active downlink BWP and the active uplink BWP are also referred to as active BWP.

The terminal device 101 may not receive the PDSCH, PDCCH, and CSI-RS in the downlink BWPs other than the active downlink BWP. The terminal device 101 may not transmit the PUCCH and PUSCH in the uplink BWPs other than the active uplink BWP. BWPs other than the active BWP is referred to as inactive BWPs.

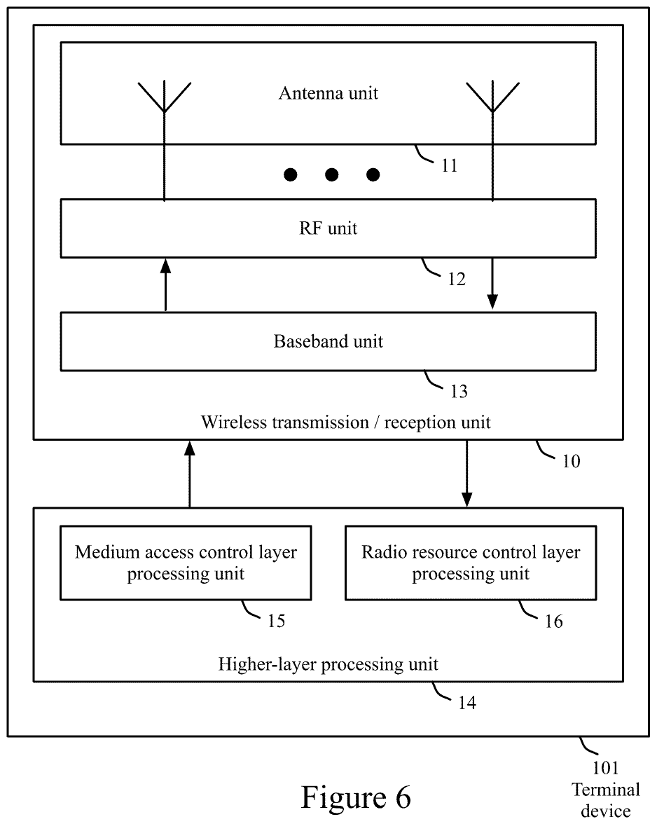

FIG. 6 is a schematic block diagram illustrating a configuration example of a terminal device, according to an example implementation of the present disclosure. The terminal device 101 may be any of the terminal devices 101A-101C, shown in FIG. 1. As shown in FIG. 6, the terminal device 101 may include a part or all of the wireless transmission and reception unit (also referred to herein as physical layer processing unit or physical layer unit) 10 and the higher-layer processing unit 14. The wireless transmission and reception unit 10 may include a part or all of the antenna unit 11, the RF unit 12, and the Baseband unit 13. The higher-layer processing unit 14 may include a part or all of the MAC layer processing unit (also referred to as the MAC entity) 15 and the RRC layer processing unit 16. The higher-layer processing unit 14 may include at least one processor (not shown in the figure) and one or more non-transitory computer-readable media (not shown in the figure) that store computer-executable instructions and data.

The wireless transmission and reception unit 10 may include a part of or all of the wireless transmission unit 10a (not shown in the figure) and the wireless reception unit 10b (not shown in the figure). The wireless transmission and reception unit 10 may include at least one processor (not shown in the figure) and one or more non-transitory computer-readable media (not shown in the figure) that store computer-executable instructions and data.

The configuration of the baseband unit 13 in the wireless transmission unit 10a and the configuration of the baseband unit 13 in the wireless reception unit 10b may be the same or different. The configuration of the RF unit 12 in the wireless transmission unit 10a and the RF unit 12 in the wireless reception unit 10b may be the same or different. The configuration of the antenna unit 11 in the wireless transmission unit 10a and the configuration of the antenna unit 11 in the wireless reception unit 10b may be the same or different.

The higher-layer processing unit 14 provides uplink data (transport blocks) to the wireless transmission and reception unit 10 (or the wireless transmission unit 10a). The higher-layer processing unit 14 may perform processing of the MAC layer, the PDCP layer, the RLC layer, and/or the RRC layer.

The MAC layer processing unit 15 in the higher-layer processing unit 14 may perform processing of the MAC layer. RRC layer processing unit 16 in the higher-layer processing unit 14 may perform the process of the RRC layer. RRC layer processing unit 16 manages various RRC parameters of the terminal device 101 based on RRC messages received from the base station device 103.

The wireless transmission and reception unit 10 (or the wireless transmission unit 10a) may perform processing, such as encoding and modulation. The wireless transmission and reception unit 10 (or the wireless transmission unit 10a) may generate a physical signal by encoding and modulating the uplink data. The wireless transmission and reception unit 10 (or the wireless transmission unit 10a) may convert OFDM symbols in the physical signal to a baseband signal by conversion to a time-continuous signal. The wireless transmission and reception unit 10 (or the wireless transmission unit 10a) may transmit the baseband signal (or the physical signal) to the base station device 103 via radio frequency. The wireless transmission and reception unit 10 (or the wireless transmission unit 10a) may arrange the baseband signal (or the physical signal) on a BWP (active uplink BWP) and transmit the baseband signal (or the physical signal) to the base station device 103.

The wireless transmission and reception unit 10 (or the wireless reception unit 10b) performs processing, such as demodulation and decoding. The wireless transmission and reception unit 10 (or the wireless reception unit 10b) may receive a physical signal in a BWP (active downlink BWP) of a serving cell. The wireless transmission and reception unit 10 (or the wireless reception unit 10b) may separate, demodulate, and decode the received physical signal, and provide the decoded information to the higher-layer processing unit 14. The wireless transmission and reception unit 10 (or the wireless reception unit 10b) may perform the channel access procedure prior to the transmission of the physical signal.

The RF unit 12 may demodulate the radio signal received via the antenna unit 11 into an analog signal, and/or removes extra frequency components. The RF unit 12 may provide the processed analog signal to the baseband unit 13. The baseband unit 13 may convert the analog signal input from RF unit 12 into a baseband signal. The baseband unit 13 may separate a portion which corresponds to CP from the baseband signal, perform FFT on the baseband signal from which the CP has been removed. The baseband unit 13 may extract components of the physical signal from the baseband signal.

The baseband unit 13 may perform IFFT on the uplink data to generate time-continuous signal, adds a CP to the generated signal, generate a baseband signal, and convert the baseband signal into an analog signal. The baseband unit 13 may provide the analog signal to the RF unit 12.

The RF unit 12 may remove extra frequency components from the analog signal input from the baseband unit 13, up-converts the analog signal to a radio frequency, and may transmit it via the antenna unit 11. RF unit 12 may have a function of controlling transmission power.

A physical signal is a generic term for physical downlink channels, physical downlink signals, physical uplink channels, and physical uplink signals. The physical channel is a generic term for physical downlink channels and physical uplink channels.

A physical uplink channel corresponds to a set of REs that carry one or both of information originating from the higher-layer and the Uplink Control Information (UCI). In the radio communication system according to one aspect of the present embodiments, a part or all of the PUCCH, PUSCH, and/or a Physical Random Access Channel (PRACH) may be used.

A PUCCH may be used to transmit the UCI. A PUCCH may be sent to deliver (transmit, convey) uplink control information. The UCI may be mapped to the PUCCH. The terminal device 101 may transmit a PUCCH in which the UCI is mapped. The base station device 103 may receive the PUCCH in which the UCI is mapped.

The Channel State Information (CSI) may be deemed as a type of UCI. The CSI is used to convey information related to the propagation path between the terminal device 101 and the base station device 103.

The Hybrid Automatic Repeat request ACKnowledgement (HARQ-ACK) information may also be deemed as a type of UCI. The HARQ-ACK information is used to convey whether the downlink data has been successfully decoded or not.

The Scheduling Request (SR) may also be deemed as a type of UCI. The SR is used to request an uplink resource (a PUSCH or a UL-SCH).

Uplink control information (uplink control information bit, uplink control information sequence, uplink control information type) includes at least part or all of the CSI, SR, and HARQ-ACK.

The CSI may include at least part or all of a channel quality indicator (CQI), a Precoder Matrix Indicator (PMI), and a Rank Indicator (RI). CQI is an indicator related to channel quality (e.g., propagation quality) or physical channel quality, and PMI is an indicator related to a precoder. RI is an indicator related to transmission rank (or the number of transmission layers).

The CSI may be provided at least based on receiving one or more physical signals (e.g., one or more CSI-RSs) used at least for channel measurement. The CSI may be selected by a terminal device at least based on receiving one or more physical signals used for channel measurement. Channel measurements may include interference measurements.

A PUSCH may be used to transmit one or both of a transport block and UCI. A PUSCH may be sent to deliver (transmit, convey) one or both of a transport block and uplink control information. The terminal device 101 may transmit a PUSCH in which one or both of a transport block and UCI is mapped. The base station device 103 may receive the PUSCH in which the one or both of the transport block and the UCI is mapped.

A PRACH may be used to transmit a random-access (RA) preamble. A PRACH may be sent to deliver (transmit, convey) an index of a random-access preamble. The terminal device 101 may transmit a PRACH. The base station device 103 may receive the PRACH.

For a given PRACH occasion (RACH occasion, RO), 64 random-access preambles are defined. The random-access preamble is specified (determined, given) based on the cyclic shift Cᵥ of the PRACH and the sequence index u for the PRACH.

A physical uplink signal corresponds to a set of REs. A physical uplink signal may not carry information generated in the higher layer. The terminal device 101 may transmit a physical uplink signal. The base station device 103 may receive the physical uplink signal. In the radio communication system according to one aspect of the present embodiment, a part or all of UL DMRS, SRS (Sounding Reference Signal (SRS), UpLink Phase Tracking Reference Signal (UL PT-RS) may be used.

UL DMRS is a generic name of a DMRS for a PUSCH and a DMRS for a PUCCH. A set of antenna ports of a DMRS for a PUSCH may be given based on a set of antenna ports for the PUSCH. For example, a set of DMRS antenna ports for a PUSCH may be the same as a set of antenna ports for the PUSCH.

A PUSCH and a DMRS for the PUSCH is collectively referred to as PUSCH. A set of antenna ports of a DMRS for a PUCCH may be given based on a set of antenna ports for the PUCCH. For example, a set of DMRS antenna ports for a PUCCH may be the same as a set of antenna ports for the PUCCH. A PUCCH and a DMRS for the PUCCH is collectively referred to as PUCCH.

A physical downlink channel corresponds to a set of REs that carry one or both of information originating from the higher-layer and Downlink Control Information (DCI). In the radio communication system according to one aspect of the present embodiment, a part or all of Physical Broadcast Channel (PBCH), Physical Downlink Control Channel (PDCCH), and Physical Downlink Shared Channel (PDSCH) may be used.

A PBCH may be used to transmit a Master Information Block (MIB). A PBCH may be sent to deliver (transmit, convey) a MIB. The terminal device 101 may receive a PBCH. The base station device 103 may transmit the PBCH.

A PDCCH may be used to transmit DCI. A PDCCH may be sent to deliver (transmit, convey) DCI. The terminal device 101 may receive a PDCCH in which DCI is mapped. The base station device 103 may transmit the PDCCH in which the DCI is mapped.

The DCI format includes a set of information fields. Each information field may mask a bit sequence of the DCI. Bits masked by an information field is associated with a specific meaning associated with the information field.

Several DCI formats may be used in the radio communication system according to one aspect of the present embodiment. Several example DCI formats are provided.

DCI format 0_0 is used for scheduling a PUSCH for a cell. The DCI format 0_0 includes a part or all of Information fields 1A to 1E. Information field 1A is a DCI format identification field. Information field 1B is a Frequency Domain Resource Assignment (FDRA) field. Information field 1C is a Time Domain Resource Assignment (TDRA) field. Information field 1D is a frequency-hopping flag field. Information field 1E is a Modulation-and-Coding-Scheme (MCS) field.

A DCI format identification field may indicate whether a DCI format including the DCI format identification field is an uplink DCI format or a downlink DCI format. The DCI format identification field included in the DCI format 0_0 indicates that the DCI format 0_0 is an uplink DCI format.

A FDRA field in a DCI format may be used to indicate assignment of frequency resources for a physical channel scheduled by the DCI format. For example, the FDRA field may indicate the number of RBs, X, for PUSCH.

A TDRA field in a DCI format may be used to indicate assignment of time resources for a physical channel scheduled by the DCI format.

In 6G radio, a TDRA field may indicate the time resource within the new time unit. For example, the TDRA field may indicate the starting OFDM symbol S in the new time unit and the length L in terms of OFDM symbols. In a case that the N^{new-unit}_{symb} is larger than N^{slot}_{symb}, the physical channel scheduled by the TDRA field may cross the slot boundary.

A frequency-hopping flag field in a DCI format may be used to indicate whether frequency-hopping is applied to a physical channel scheduled by the DCI format.

A MCS field in a DCI format may be used to indicate one or both of a modulation scheme for a physical channel scheduled by the DCI format and a target code rate for the physical channel. The target code rate is used to determine a Transport Block Size (TBS) for the physical channel.

The DCI format 0_0 may not include fields used for a CSI request. That is, CSI may not be requested by the DCI format 0_0.

The DCI format 0_0 may not include a carrier indicator field. If an uplink DCI format does not include a carrier indicator field, the terminal device 101 may determine that an uplink component carrier on which a PUSCH scheduled by the uplink DCI format is mapped is an uplink component carrier in a serving cell which includes a downlink component carrier on which a PDCCH with the uplink DCI format is mapped.

The DCI format 0_0 may not include a BWP indicator field. If a DCI format does not include a BWP indicator field, the terminal device 101 may determine that active BWP change has not been triggered by the DCI format.

DCI format 0_1 may be used for scheduling of a PUSCH for a cell. The DCI format 0_1 includes a part or all of Information fields 2A to 2H. Information field 2A is a DCI format identification field. Information field 2B is a FDRA field. Information field 2C is a TDRA field. Information field 2D is a frequency-hopping flag field. Information field 2E is an MCS field. Information field 2F is a CSI request field. Information field 2G is a BWP field. Information field 2H is a carrier indicator field.

The DCI format identification field in the DCI format 01 may indicate that the DCI format 0_1 is an uplink DCI format.

The CSI request field may be used to request CSI reporting.

If the DCI format 0_1 includes a BWP field, the BWP field may be used to indicate an uplink BWP on which a PUSCH scheduled by the DCI format 0_1 is mapped.

If the DCI format 0_1 includes the carrier indicator field, the carrier indicator field may be used to indicate an uplink component carrier on which a PUSCH is mapped.

DCI format 1_0 may be used for scheduling of a PDSCH for a cell. The DCI format 1_0 includes a part or all of Information fields 3A to 3F. Information field 3A is a DCI format identification field. Information field 3B is a FDRA field. Information field 3C is a TDRA field. Information field 3D is an MCS field. Information field 3E is a PDSCH-to-HARQ-feedback indicator field. Information field 3F is a PUCCH resource indicator field. The DCI format identification field in the DCI format 1_0 indicates that the DCI format 1_0 is a downlink DCI format.

The PDSCH-to-HARQ-feedback timing indicator field may be used to indicate the offset (K1) from a slot in which the last OFDM symbol of a PDSCH scheduled by the DCI format is included to another slot in which the first OFDM symbol of a PUCCH triggered by the DCI format 1_0 is mapped. The PUCCH resource indicator field may be used to indicate a PUCCH resource.

In 6G radio, the PDSCH-to-HARQ-feedback timing indicator field may be used to indicate the offset (K1) from a new time unit in which the last OFDM symbol of a PDSCH scheduled by the DCI format is included to another new time unit in which the first OFDM symbol of a PUCCH triggered by the DCI format 1_0 is mapped.

In 6G radio, the PDSCH-to-HARQ-feedback timing indicator field may be used to indicate the offset (K1) from a slot in which the last OFDM symbol of a PDSCH scheduled by the DCI format is included to another slot in which the first OFDM symbol of a PUCCH triggered by the DCI format 1_0 is mapped.

The DCI format 1_0 may not include the carrier indicator field. If a downlink DCI format does not include the carrier indicator field, the terminal device 101 may determine that a downlink component carrier on which a PDSCH scheduled by the downlink DCI format is mapped is the downlink component carrier on which the PDCCH with the DCI format 1_0 is mapped. The DCI format 1_0 may not include the BWP field.

The DCI format 1_1 may be used for scheduling of a PDSCH for a cell. The DCI format 1_1 includes a part or all of Information fields 4A to 4H. Information field 4A is a DCI format identification field. Information field 4B is a FDRA field. The 4C is a TDRA field. Information field 4D is an MCS field. Information field 4E is a PDSCH-to-HARQ-feedback indicator field. Information field 4F is a PUCCH resource indicator field. Information field 4G is a BWP field. Information field 4H is a carrier indicator field. The DCI format identification field in the DCI format 1_1 may indicate that the DCI format 1_1 is a downlink DCI format.

A PDSCH may be used to transmit a transport block. A PDSCH may be sent to deliver (transmit, convey) a transport block. The base station device 103 may transmit a PDSCH. The terminal device 101 may receive the PDSCH.

A physical downlink signal corresponds to a set of REs. A physical downlink signal may not carry the information generated in the higher layer. The base station 103 transmits a physical downlink signal. The terminal device 101 may receive the physical downlink signal. In the radio communication system according to one aspect of the present embodiment, at least a part or all of a Synchronization signal (SS), DownLink DeModulation Reference Signal (DL DMRS), Channel State Information-Reference Signal (CSI-RS), and DL PT-RS may be used.

A synchronization signal may be used to synchronize in the frequency domain and time domain for downlink. The synchronization signal is a generic name of Primary Synchronization Signal (PSS) and Secondary Synchronization Signal (SSS).

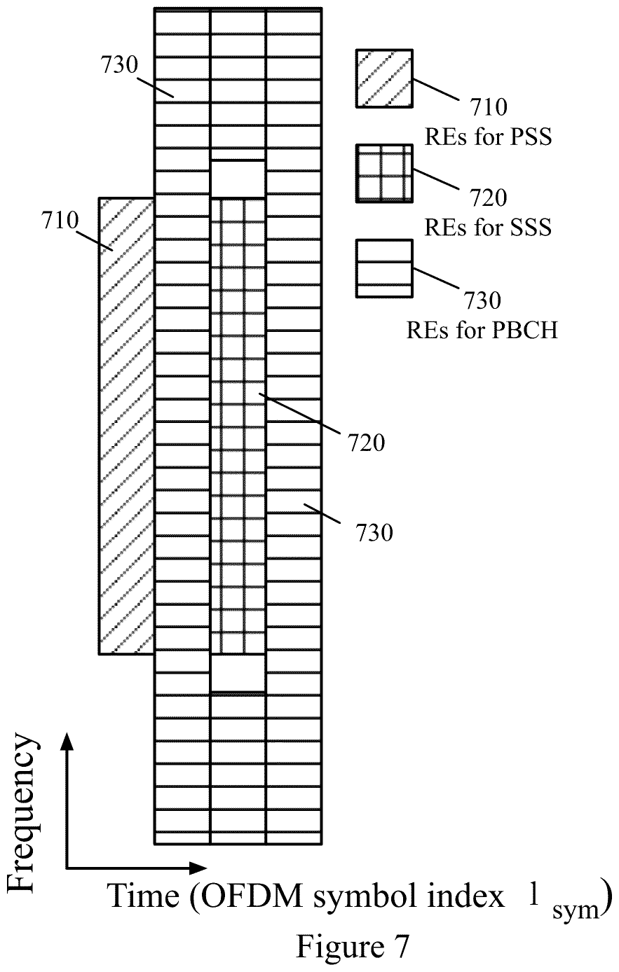

FIG. 7 is a diagram illustrating an example configuration of a synchronization signal/physical broadcast channel (SS/PBCH) block including a primary synchronization signal (PSS) and a secondary synchronization signal (SSS), according to an example implementation of the present disclosure. In FIG. 7, the horizontal axis represents the OFDM symbol index l_{sym}, and the vertical axis represents the frequency domain. The shaded blocks 710 represent a set of REs for the PSS. The block of grid lines 720 represents a set of REs for the SSS. Also, the blocks in the horizontal line 730 represent a set of REs for the PBCH and a set of REs for a DMRS for the PBCH.

The SS/PBCH block in FIG. 7 includes a PSS, an SSS, and a PBCH. The SS/PBCH block includes 4 consecutive OFDM symbols and 240 subcarriers. The PSS is allocated to the 57th to 183rd subcarriers in the first OFDM symbol. The SSS is allocated to the 57th to 183rd subcarriers in the third OFDM symbol. The first to 56th subcarriers of the first OFDM symbol may be set to zero. The 184th to 240th subcarriers of the first OFDM symbol may be set to zero. The 49th to 56th subcarriers of the third OFDM symbol may be set to zero. The 184th to 192nd subcarriers of the third OFDM symbol may be set to zero. In the first to 240th subcarriers of the second OFDM symbol, the PBCH is allocated to subcarriers in which the DMRS for the PBCH is not allocated. In the first to 48th subcarriers of the third OFDM symbol, the PBCH is allocated to subcarriers in which the DMRS for the PBCH is not allocated. In the 193rd to 240th subcarriers of the third OFDM symbol, the PBCH is allocated to subcarriers in which the DMRS for the PBCH is not allocated. In the first to 240th subcarriers of the 4th OFDM symbol, the PBCH is allocated to subcarriers in which the DMRS for the PBCH is not allocated.

The antenna ports of the PSS, the SSS, the PBCH, and the DMRS for the PBCH in an SS/PBCH block may be identical. DL DMRS is a generic name of a DMRS for a PBCH, a DMRS for a PDSCH and a DMRS for a PDCCH.

A set of antenna ports of a DMRS for a PDSCH may be given based on a set of antenna ports for the PDSCH. For example, a set of DMRS antenna ports for a PDSCH may be the same as a set of antenna ports for the PDSCH.

A PDSCH and a DMRS for the PDSCH is collectively referred to as PDSCH. A set of antenna ports of a DMRS for a PDCCH may be given based on a set of antenna ports for the PDCCH. For example, a set of DMRS antenna ports for a PDCCH may be the same as a set of antenna ports for the PDCCH. A PDCCH and a DMRS for the PDCCH is collectively referred to as PDCCH.

A Broadcast Channel (BCH), an Uplink-Shared Channel (UL-SCH). and a Downlink-Shared Channel (DL-SCH) are transport channels. A channel used in the MAC layer is called a transport channel. A unit of transport channel used in the MAC layer is also called transport block (TB) or MAC Protocol Data Unit (MAC PDU). In the MAC layer, control of Hybrid Automatic Repeat request (HARQ) is performed for each transport block. The transport block is a unit of data delivered by the MAC layer to the physical layer. In the physical layer, transport blocks are mapped to codewords and modulation processing is performed for each codeword.

One UL-SCH and one DL-SCH may be provided for each serving cell. BCH may be given to PCell. BCH may not be given to PSCell and SCell.

A Broadcast Control Channel (BCCH), a Common Control Channel (CCCH), and a Dedicated Control Channel (DCCH) are logical channels. The BCCH is a channel of the RRC layer used to deliver MIB or other system information blocks. The CCCH may be used to transmit a common RRC message in multiple terminal devices. The DCCH may be used to transmit a dedicated RRC message to a terminal device.

The BCCH in the logical channel may be mapped to the BCH or the DL-SCH in the transport channel. The CCCH in the logical channel may be mapped to the DL-SCH or the UL-SCH in the transport channel. The DCCH in the logical channel may be mapped to the DL-SCH or the UL-SCH in the transport channel.

The UL-SCH in the transport channel may be mapped to a PUSCH in the physical channel. The DL-SCH in the transport channel may be mapped to a PDSCH in the physical channel. The BCH in the transport channel may be mapped to a PBCH in the physical channel.

A higher-layer parameter is a parameter in an RRC message or a MAC CE (Control Element). A higher-layer parameter may be a cell-specific parameter or a UE-specific parameter. A cell-specific parameter is a parameter including a common configuration in a cell. A UE-specific parameter is a parameter including a configuration that may be configured differently for each UE.

The BS 103 may indicate change of cell-specific parameters by reconfiguration with random-access. The BS 103 may indicate change of UE-specific parameters by reconfiguration with or without random-access.

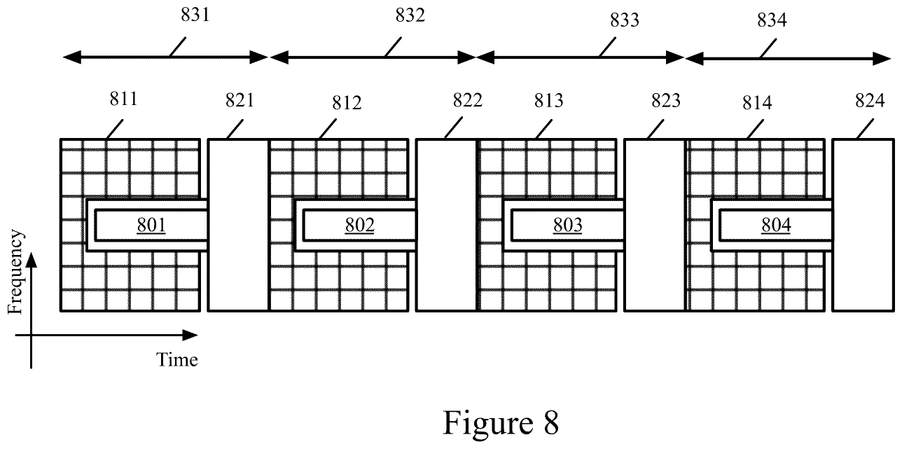

FIG. 8 is a time-frequency diagram illustrating an example resource partitioning in a serving cell, according to an example implementation of the present disclosure. The horizontal axis represents the time domain. The vertical axis represents the frequency domain. The regions 801, 802, 803, and 804 represent the time-frequency resources for a UL subband. The regions 811, 812, 813, and 814 with grid lines represent DL regions. The regions 821, 822, 823, and 824 represent UL regions. The lines 831, 832, 833, and 834 represent periods of the time division duplexing (TDD) pattern. Each region represents a resource for each SS/PBCH block with a different index. Time domain guard periods are placed on a switching location from DL to UL. Frequency domain guard bands are placed on a boundary of DL and UL.

TDD pattern is a pattern including a part of all the DL region, flexible region, and UL region. In FIG. 8, the TDD pattern includes the DL region and the UL region. The time domain guard period between the DL region and UL region may be as part of the DL region, as part of the UL region, or flexible region. The TDD pattern may be configured based on one or more RRC parameters provided by the RRC layer. The length of the pattern may be configured based on one or more RRC parameters provided by the RRC layer.

The UL subband may be configured in one or both of the DL region and the time domain guard period. The time domain resource of the UL subband may be configured by one or more RRC parameters provided by the RRC layer.

The time domain resource of the UL subband may be configured by one or more first RRC parameters used to indicate a periodicity of the UL subband, one or more second RRC parameters used to indicate the starting slot of the UL subband in each period, and one or more third RRC parameters used to indicate the length of the UL subband in each period in number of slots. For example, in a case that the periodicity is 20 slots, the starting slot is the 3rd slot, and the length is 11 slots, the terminal device 101 determines that the UL subband with length of 11 slots starting at the 3rd slot is placed in each periodicity.

One or more first RRC parameters used to indicate the periodicity may be one or more RRC parameters different from the one or more RRC parameters used to indicate the periodicity of the TDD pattern. For example, the one or more RRC parameters used to indicate the periodicity of the TDD pattern may be reused to indicate the periodicity of the UL subband. For example, the terminal device 101 may assume the periodicity of the UL subband is the same as the periodicity of the TDD pattern.

One or more fourth RRC parameters may be used to indicate the starting OFDM symbol of the UL subband in the starting slot. For example, one or more fifth RRC parameters may be used to indicate the length of the UL subband in number of symbols. For example, the frequency domain resource of the UL subband may be configured by one or more first RRC parameters used to indicate the starting RB of the UL subband and one or more second RRC parameters used to indicate the length of the UL subband in number of RBs.

The UL subband may be configured in an SCS-specific carrier. Therefore, in this case, the RRC parameters used to indicate resources of the UL subband may be provided per SCS-specific carrier. The UL subband may be configured in a BWP. Therefore, in this case, the RRC parameters used to indicate resources of the UL subband may be provided per BWP.

Using the UL subband, the base station device 103 may perform simultaneous transmission and reception at a time. For example, in a time occasion with UL subband 801, the base station device 103 performs transmission of physical downlink channels in the region 811 and reception of physical uplink channels in the region 801 at a time. The time occasion where the UL subband is mapped is referred to as a SubBand Full Duplex (SBFD) region.

Various physical layer configurations may be independently provided for the SBFD region and non-SBFD region. For example, the base station device 103 may use different QCL properties for the SBFD region and the non-SBFD region. The base station device 103 may use different settings for the components of the RF unit 32. For example, the components may include analog filters, amplifiers, or clocks. The terminal device 101 may obtain information related to the various physical layer configurations from the base station device 103.

Random-access (RA) may be used for various purposes. For example, RA may be used for scheduling requests or uplink timing synchronization. The RA procedures are crucial for establishing initial communication between the UE and the network, in scenarios such as initial network access, handovers, and when the UE needs to move from an idle state to a connected state.

At least two modes are available for RA: (1) Contention-Based Random-Access (CBRA) and (2) Contention-Free Random-Access (CFRA). In a CBRA procedure, the UE may select an RA preamble from a pool shared with other UEs. In a CBRA procedure, multiple UEs may select the same preamble. In a CFRA procedure, the BS may allocate a dedicated RA preamble for the UE to ensure different UEs use different preambles.

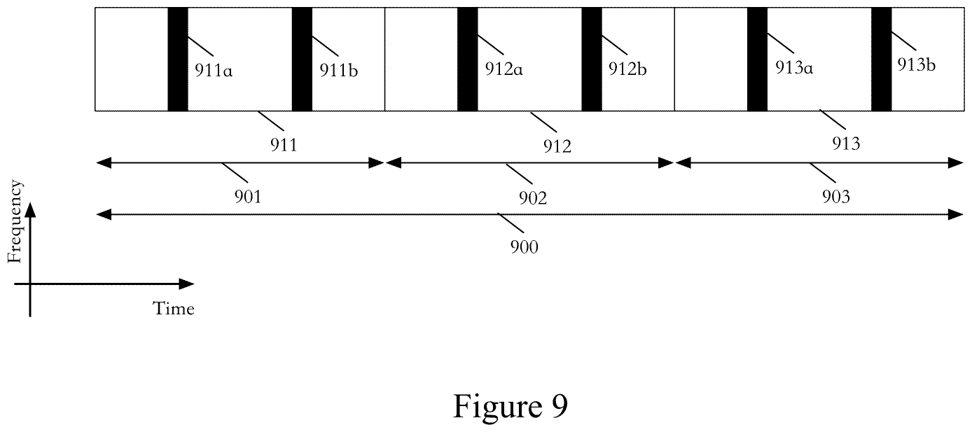

FIG. 9 is a time domain diagram illustrating an example resource definition in a serving cell, according to an example implementation of the present disclosure. In FIG. 9, the line 900 represents the new time unit, the lines 901 to 903 represent slots, the boxes 911 to 913 represent channel units, and the symbols 911a to 913a and 911b to 913b represent OFDM symbols reserved for DMRS. In the example shown in FIG. 9, slot-aggregation factor is 3, in which slots 901 to 903 are aggregated. A physical channel (e.g., PDSCH, PUSCH, PUCCH, PDCCH) includes channel units 911, 912, and 913. DMRS mapping is with respect to the slots.

In some implementations, the DMRS mapping may be defined with respect to the slots. The DMRS mapping may be defined as the set of OFDM symbol indices in a slot. For example, if the DMRS symbol index is defined as 1=x₁, x₂, x₃, DMRS is mapped to the OFDM symbol indices 1=x₁, x₂, x₃ in each channel unit. For a single physical channel, the DMRS symbol index in each channel unit may be the same.

The slot-aggregation factor may be determined or indicated by information provided by system information. For example, the slot-aggregation factor may be determined or indicated by information provided by MIB or other system information blocks.

The slot-aggregation factor may be determined or indicated by downlink control information multiplexed in PBCH. The slot-aggregation factor may be determined or indicated by information provided by RRC reconfiguration message. The slot-aggregation factor may be determined or indicated by information provided by DCI formats.

The UE may identify how a PDSCH is scheduled to select a slot-aggregation factor to be applied. For a PDSCH to convey system information scheduled by a DCI format 1_0, the slot-aggregation factor determined or indicated by information provided by the DCI format 1_0 may be applied to the PDSCH. For a PDSCH which is different from the PDSCH to convey the system information and is scheduled by a DCI format 1_0, the slot-aggregation factor determined or indicated by information provided by MIB or other system information blocks may be applied to the PDSCH. For a PDSCH scheduled by a DCI format 1_1, the slot-aggregation factor determined or indicated by information provided by RRC reconfiguration message may be applied to the PDSCH.

In some implementations, candidate values of slot-aggregation factor may be limited by the frequency range of the cell. For example, in a case that the cell is in a first frequency range, the candidate values may be 1, 2, and 4, and in a case that the cell is in a second frequency range, the candidate values may be 2, 4, and 8.

In some implementations, the candidate values of slot-aggregation factor may be limited by the subcarrier spacing of the SCS-specific carrier. For example, in a case that the subcarrier spacing of the first SCS-specific carrier is X, the candidate values may be 1, 2, and 4 and in a case that the subcarrier spacing of the first SCS-specific carrier is Y, the candidate values may be 2, 4, and 8.

### Mapping of Phase Tracking Reference Signal to Resource Blocks

The phase tracking reference signal (PT-RS or PTRS) is a reference signal used in wireless communication systems, such as 5G NR or 6G. Its primary purpose is to facilitate phase tracking, which is critical for compensating phase noise and frequency offsets caused by impairments in the RF chain or oscillator inaccuracies.

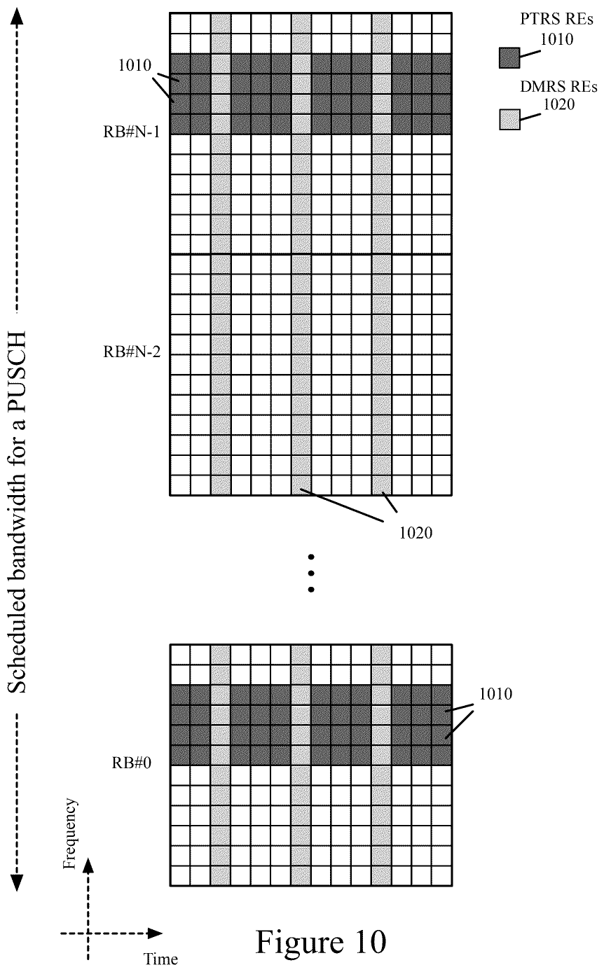

PT-RS is not effectively transmitted when the UE performs PUSCH transmissions in SBFD symbols. When transform precoding is performed, PT-RS is distributed in the frequency domain, and in some cases, PT-RS is mapped only at the edge RBs in the scheduled bandwidth as shown in FIG. 10.

FIG. 10 is a diagram illustrating PT-RS mapping when transform precoding is enabled, according to an example implementation of the present disclosure. In the example of FIG. 10, N RBs (RB #0 to RB #N−1) are scheduled and PT-RS is mapped only in RB #0 and RB #N−1 (only some of the REs are labelled for clarity). This is because, when transform precoding is performed, the “frequency domain” becomes a virtual concept and it actually is the time domain. Considering that PT-RS should be distributed in the time domain, the PT-RS should be distributed in the “virtual frequency domain.” It should be noted that, in some implementations, DMRS is first mapped to the REs 1020, then PT-RS is mapped to the REs 1010.

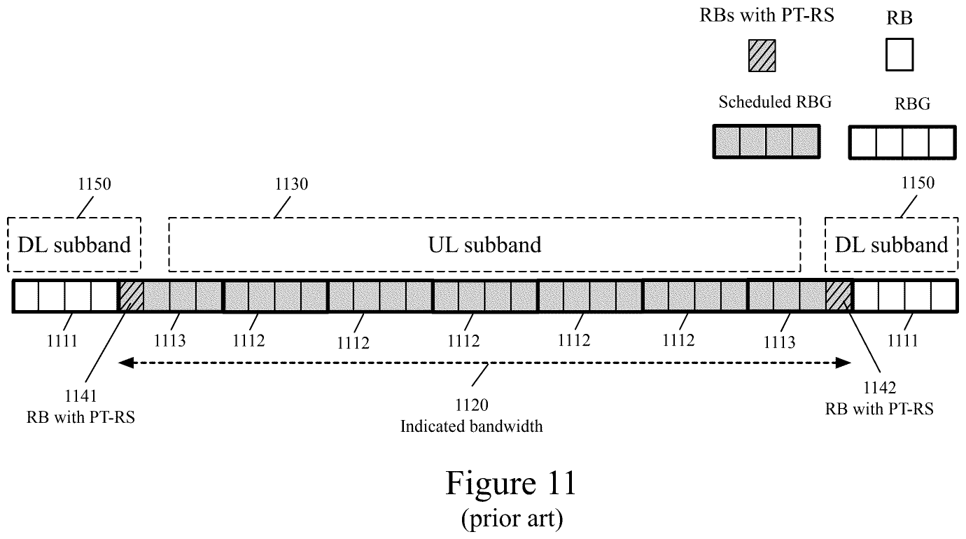

In the SBFD, the edge RBs are subject to invalidation to align the scheduled bandwidth into the UL subband, as shown in FIG. 11. FIG. 11 is a diagram illustrating an example of scheduling RBs in the UL subband, according to prior art. In FIG. 11, RBG-based scheduling is used. Thus, the BS allocates continuous RBGs 1111, 1112, and 1113, as shown in the figure, where RBG size=4 RBs. The RBG size may be much larger than 4 RBs, for example, the RBG size may be 16 RBs or 32 RBs.

In the example of FIG. 11, a portion 1120 of the bandwidth is indicated by the BS for UL PUSCH transmission. The indicated bandwidth 1120 includes the RBGs 1112 and 1113 that are scheduled by the BS for the UL PUSCH transmission.

Furthermore, configurability of UL subband 1130 size and location may not be flexible since the UL subband size and location may have major impact to the BS's hardware implementation. On the other hand, the UL subband 1130 does not necessarily align with the RBG grid. Therefore, some RBGs, such as the RGBs 1113, may cross the UL subband 1130 boundary into the DL subband 1150 boundary of into the guard region between the UL subband 1130 and the DL subband 1150. In this case, an edge RB (such as the RBs 1141 and 1142) outside the UL subband 1130 must be invalidated. Otherwise, it may cause critical system errors.

However, PT-RS needs to be mapped at the edge of the bandwidth indicated by FDRA field in the scheduling DCI. For example, in FIG. 11, the RBs 1141 and 1142 represent the RBs with PT-RS. In this case, the RBs 1141 and 1142 with the PT-RS are outside the UL subband 1130, and thus, the PT-RS will not be transmitted. The issue here is that PT-RS is not effectively mapped within the UL subband.

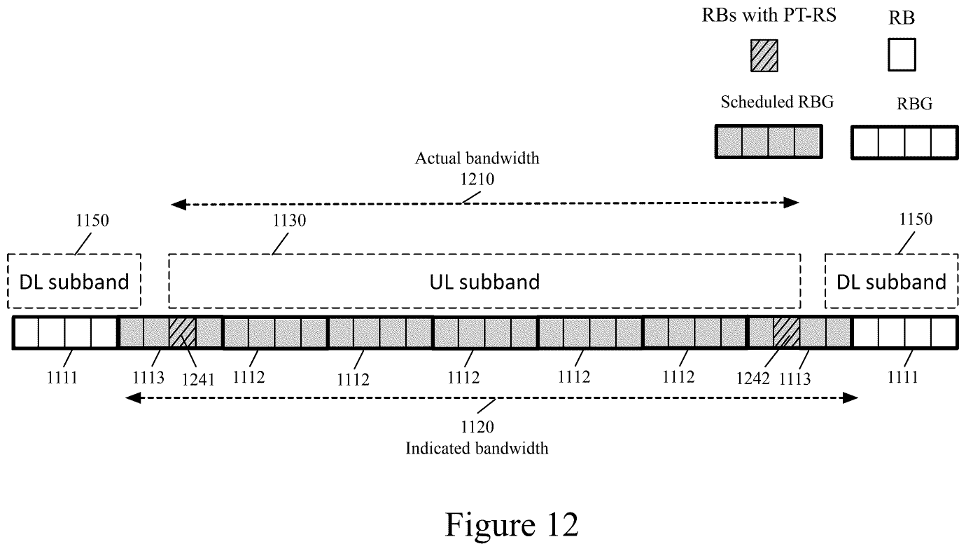

FIG. 12 is a diagram illustrating an example of PT-RS mapping enhancement, according to an example implementation of the present disclosure. In FIG. 12, the “actual bandwidth” is defined as a set of RBs derived from intersection of the RBs in the UL subband and the RBs indicated by the FDRA field. In the example of FIG. 12, such set of RBs includes the RBs 1241 and 1242 and the RBs in the RBGs 1112 between them.

In order to address the shortcomings of the prior art, the PT-RS mapping, in some of the present embodiments, is with respect to the actual bandwidth, not to the indicated bandwidth. Accordingly, the UE may map PT-RS at the edge subcarriers in the actual bandwidth where the actual bandwidth 1210 is a set of RBs derived from intersection of the RBs in the UL subband 1130 and the RBs indicated by the FDRA field. Using the actual bandwidth 1210, instead of the bandwidth 1120 indicated by the BS for scheduling the PUSCH, provides the technical advantage of avoiding the invalidation of the edge RBs with the PT-RS.

Each RE may correspond to one subcarrier in the frequency-domain and one symbol in the time-domain. PT-RS at the lower edge of the actual bandwidth may be mapped from subcarrier #0 to subcarrier

$$( {N}_{group}^{PT - RS} - 1 ) .$$

PT-RS at the higher edge of the actual bandwidth may be mapped from subcarrier

$$( {M}_{sc}^{PUSCH} - {N}_{group}^{PT - RS} )$$

to subcarrier

$$( {M}_{sc}^{PUSCH} - 1 ) ,$$

where subcarrier #0 is the lowest frequency subcarrier of the actual bandwidth and

$${M}_{sc}^{PUSCH}$$

is the number of subcarriers in the actual bandwidth.

Separate configuration for the number of PT-RS groups

$${N}_{group}^{PT - RS}$$

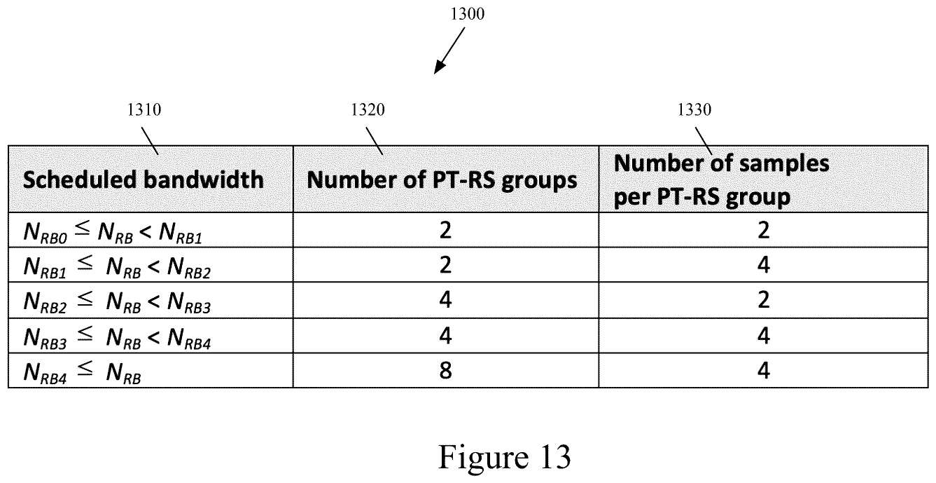

may be provided for each symbol type. For example, the configuration parameters indicating N_{RB0} to N_{RB4} may be provided for each symbol type. FIG. 13 illustrates a table 1300 that includes an example PT-RS group pattern as a function of the indicated bandwidth, according to an example implementation of the present disclosure. With reference to FIG. 13, the table 1300 may be maintained by the BS and the UE, and may provide the number of PT-RS groups 1520 and the number of samples per PT-RS group 1530 as a function of the number of RBs 1310, N_{RB}.

### PUSCH Allocation Using RBG

A PUSCH may be scheduled by the BS using a DCI format. The DCI format may include an FDRA field. The FDRA field may include a number of bits each of which may indicate whether a corresponding RBG is allocated for the PUSCH. For example, the number of bits for the FDRA field may be equal to the number of RBGs defined in the UL BWP.

The RBG size may be dependent on the number of RBs in the UL BWP. For example, the RBG size may be 4 (e.g., as shown in the examples of FIGS. 11-12) for a certain range of RBs in the UL BWP and the RBG size may be 16 for another certain range of RBs in the UL BWP.

RBG Handling when it Crosses the UL Subband Boundary

In a case that a scheduled RBG (such as the RBGs 1113 shown in FIG. 12) crosses the UL subband 1130 boundary, only the RBs within the UL subband 1130 may be valid for the PUSCH transmission and other RBs outside the UL subband may be invalid for the PUSCH transmission.

### PT-RS Mapping

PT-RS mapping, according to the current 3GPP specification, is determined based at least on (1) the indicated bandwidth (e.g., the bandwidth indicated by the BS in the FDRA filed of the DCI), (2) the number of samples per PT-RS group

$${N}_{samp}^{group} ,$$

and (3) the number of PT-RS groups

$${N}_{group}^{PT - RS} .$$

Specific combination of the values

$${N}_{samp}^{group} and {N}_{group}^{PT - RS}$$

associates with a specific PT-RS mapping criterion. For example, in the case of

$$[ {N}_{samp}^{group} , {N}_{group}^{PT - RS} ] = [ 2 , 2 ] ,$$

PT-RS is mapped in subcarriers with index

$$m = s ⌊ {M}_{sc}^{PUSCH} / 4 ⌋ + k - 1.$$

Here, s may be 1, 3 and k may be 0, 1. In this case, when

$${M}_{sc}^{PUSCH}$$

is 144, m=s*36+k−1=35, 36, 107, 108.

In another example, in the case of

$$[ {N}_{samp}^{group} , {N}_{group}^{PT - RS} ] = [ 4 , 2 ] ,$$

PT-RS is mapped in subcarriers with index

$$m = {sM}_{sc}^{PUSCH} + k .$$

Here, in a case that s is 0, k is 0, 1, 2, and 3, and in a case that s is 1, k is −4, −3, −2, and −1. In this case, when

$${M}_{s c}^{PUSCH}$$

is 144, m=0, 1, 2, 3, 140, 141, 142, and 143. In this case, PT-RS is mapped only at the edge RBs.

### Technical Problem of PT-RS Mapping to be Solved

As shown in FIG. 11, the edge RBs are potentially invalidated in case that the RBs are outside of the UL subband. However, in the case of

$$[ {N}_{samp}^{group} , {N}_{group}^{PT - RS} ] = [ 4 , 2 ] ,$$

PT-RS is mapped only at the edge RBs.

### Technical Solution for PT-RS Mapping

The UE may receive a PDCCH with a DCI addressed to the UE. The UE may interpret the contents of the DCI. The UE may determine that a PUSCH transmission is scheduled (or granted) for the UE. The UE may determine the indicated bandwidth of the PUSCH transmission from a FDRA field in the DCI.

In a case that the PUSCH transmission is scheduled on non-SBFD symbols, the UE may determine the mapping of PT-RS associated with the PUSCH transmission, using the indicated bandwidth, as shown in FIG. 11. To determine the mapping of the PT-RS, the UE may determine values of the parameters

$${N}_{samp}^{group} and {N}_{group}^{PT - RS} .$$

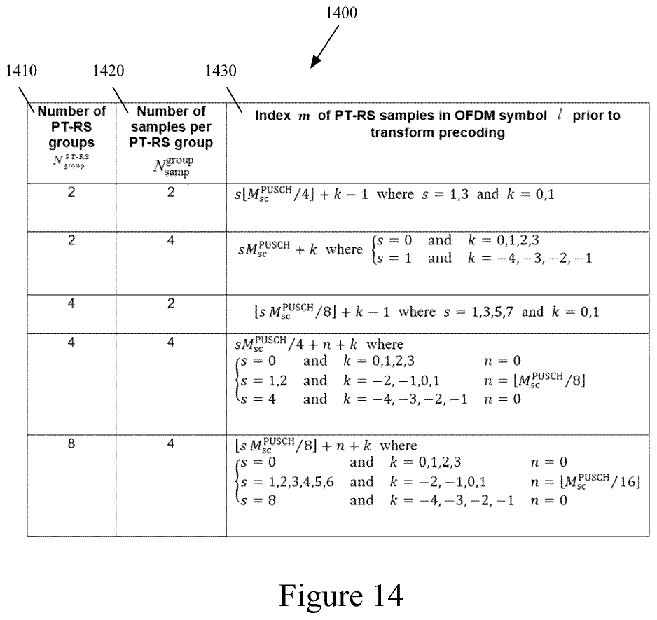

The values are provided by the respective RRC parameters from higher layers. The UE may determine an index set, m, of PT-RS samples in an OFDM symbol (e.g., OFDM symbol l). The index m may be the subcarrier index, where m=0 points to the lowest frequency subcarrier in the indicated bandwidth. FIG. 14 illustrates a table 1400 that includes an example relationship between the parameters

$${N}_{samp}^{group} 1410 , {N}_{group}^{PT - RS} 1420 ,$$

and the PT-RS allocation index m 1430, according to an example implementation of the present disclosure. With reference to FIG. 14, for each pair of values for

$${N}_{samp}^{group} 1410 and {N}_{group}^{PT - RS} 1420 ,$$

a formula may be retrieved from column 1430 that may be used to determine the index m for PT-RS mapping.

On the other hand, in a case that the PUSCH transmission is scheduled on the SBFD symbols, the UE may determine the mapping of PT-RS associated with the PUSCH transmission, using the actual bandwidth, as shown in FIG. 12. To determine the mapping of the PT-RS, the UE may determine the values of the parameters

$${N}_{samp , SBFD}^{group} and {N}_{group , SBFD}^{PT - RS} .$$

The values are provided by the respective RRC parameters from higher layers. In some cases, those values may be shared for the PUSCH transmissions in SBFD symbols and in non-SBFD symbols. In other cases, the values of the parameters

$${N}_{samp , SBFD}^{group} and {N}_{group , SBFD}^{PT - RS}$$

may be provided by different parameters from those provisioning the values of

$${N}_{samp}^{group} and {N}_{group}^{PT - RS} .$$

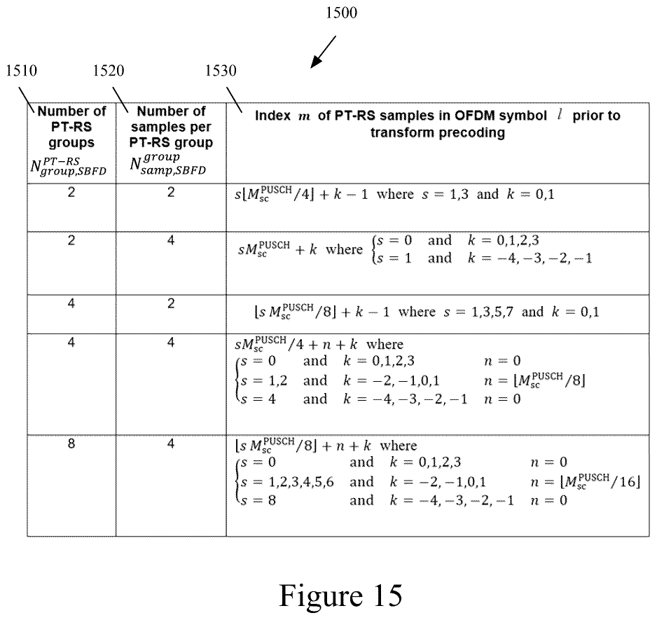

The UE may determine the index set m of PT-RS samples in OFDM symbol l using the table 1500 shown in FIG. 15. FIG. 15 illustrates a table 1500 that includes an example relationship between the parameters

$${N}_{samp , SBFD}^{group} 1510 , {N}_{group , SBFD}^{PT - RS} 1520 ,$$

and the PT-RS allocation index m 1530, according to an example implementation of the present disclosure. With reference to FIG. 15, for each pair of values for

$${N}_{samp , SBFD}^{group} 1510 and {N}_{group , SBFD}^{PT - RS} 1520 ,$$

a formula may be retrieved from column 1530 that may be used to determine the index m for PT-RS mapping. The index m would be the subcarrier index, where m=0 points to the lowest frequency subcarrier in the actual bandwidth.

Here, the actual bandwidth may be a bandwidth defined by the intersection of the RBs (e.g., RB 1241, RB 1242, and RBs in the RBGs 1112 shown in FIG. 12) in the UL subband 1130 and the bandwidth 1120 indicated by the BS. In other words, the actual bandwidth may be the indicated bandwidth which excludes the RBs outside of the UL subband.

The UL subband 1130 may be also referred to as UL usable RBs. The actual bandwidth may be also referred to as effective bandwidth, scheduled bandwidth, active bandwidth, reference bandwidth, or usable bandwidth, or useful bandwidth.

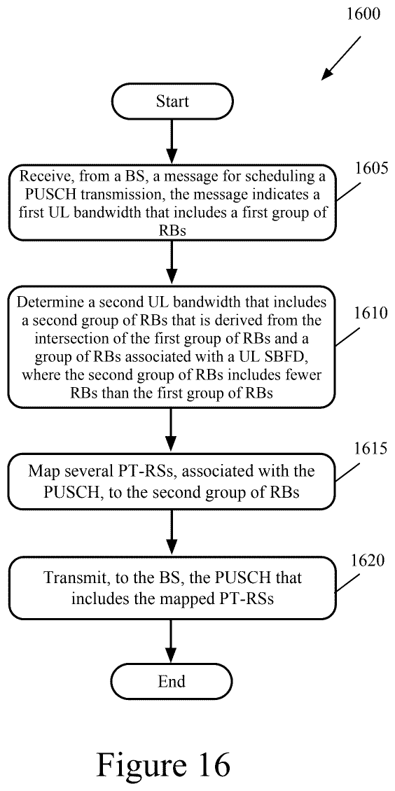

FIG. 16 is a flowchart illustrating an example method/process 1600 performed by a UE to map PT-RS to RBs, according to an example implementation of the present disclosure. The process 1600 may be performed by at least one processor of a UE 101A-101C, shown in FIG. 1.

The process 1600 may receive (at block 1605), from a BS, a message for scheduling a PUSCH transmission. The message may indicate a first UL bandwidth that includes a first group of RBs. For example, the first UL bandwidth may be the indicated bandwidth 1120 shown in FIGS. 11 and 12. The process 1600, in some embodiments, may receive a DCI message that may include an FDRA filed. The FDRA field may include several bits. Each bit may indicate whether a corresponding RB group is allocated for the PUSCH. The process 1600 may receive the DCI in a PDCCH.

The process 1600 may determine (at block 1610) a second UL bandwidth that includes a second group of RBs that is derived from the intersection of the first group of RBs and a group of RBs associated with a UL SBFD. The second group of RBs includes fewer RBs than the first group of RBs. For example, the process 1600 may determine the actual bandwidth 1210 shown in FIG. 12 as the intersection of the RBs in the UL subband 1130 and the RBs in the indicated bandwidth 1120.

The process 1600 may map (at block 1615) several PT-RSs, associated with the PUSCH, to the second group of RBs. For example, the process 1600 may map the PT-RSs, associated with the PUSCH, to the RBs 1241 and 1242, as shown in FIG. 12. The process 1600, in some embodiments, may receive, from the BS, the number of PT-RS groups and the number of samples per PT-RS group. The process 1600 may determine several subcarrier indexes based on the number of PT-RS groups and the number of samples per PT-RS group. The process 1600 may then map the PT-RSs to the second group of RBs starting at the determined subcarrier indexes. The process 1600, in some embodiments, may determine the subcarrier indexes as a function of the total number of subcarriers in the second UL bandwidth. The process 1600 may receive the number of PT-RS groups and the number of samples per PT-RS group, from the BS, in RRC signaling.

The process 1600 may transmit (at block 1620), to the BS, the PUSCH that includes the mapped PT-RSs. The process 1600 may then end.

### Mapping of Data and Uci to Resource Elements

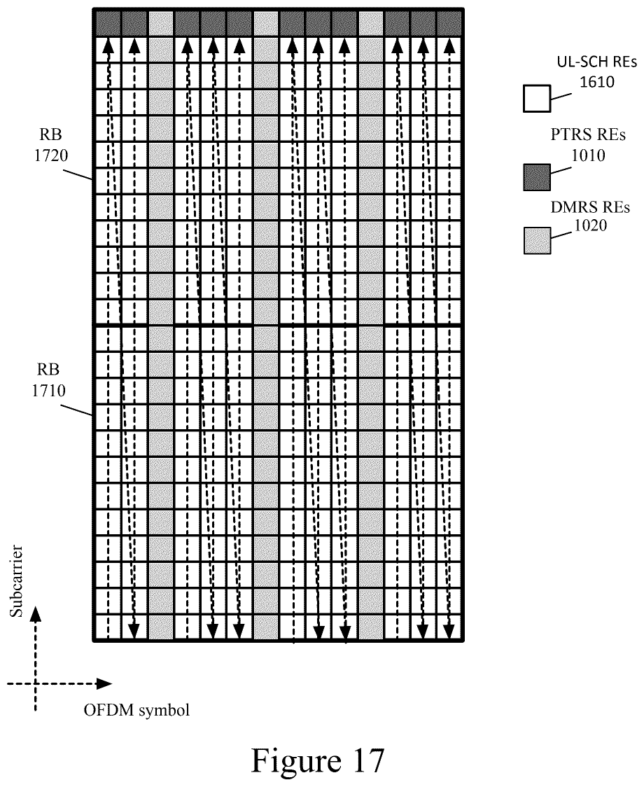

Data and control information multiplexing procedures have another issue similar to the problem mentioned above for PT-RS mapping. UCI may include HARQ-ACK, CSI part 1, and CSI part 2. Data and UCI may be multiplexed in several steps, as described below. FIG. 17 is a diagram illustrating the UL-SCH data sequence mapping to REs in frequency-first time-second manner, according to an example implementation of the present disclosure. First, the UL-SCH data sequence may be mapped to REs in frequency-first time-second manner. In the example of FIG. 17, only two RBs 1710 and 1720 are shown for simplicity. It should be understood that the UL-SCH data sequence may be mapped to REs in more than two RBs.

As shown in FIG. 17, the sequence mapping is in the frequency order first. When the UL-SCH data sequence is mapped to the highest frequency in one OFDM symbol, the next coded modulation data symbol in the UL-SCH data sequence is mapped to the lowest frequency in the next OFDM symbol. In the mapping procedure, the UE avoids mapping the UL-SCH data sequence to the REs reserved for DMRS, PT-RS, or other purposes.

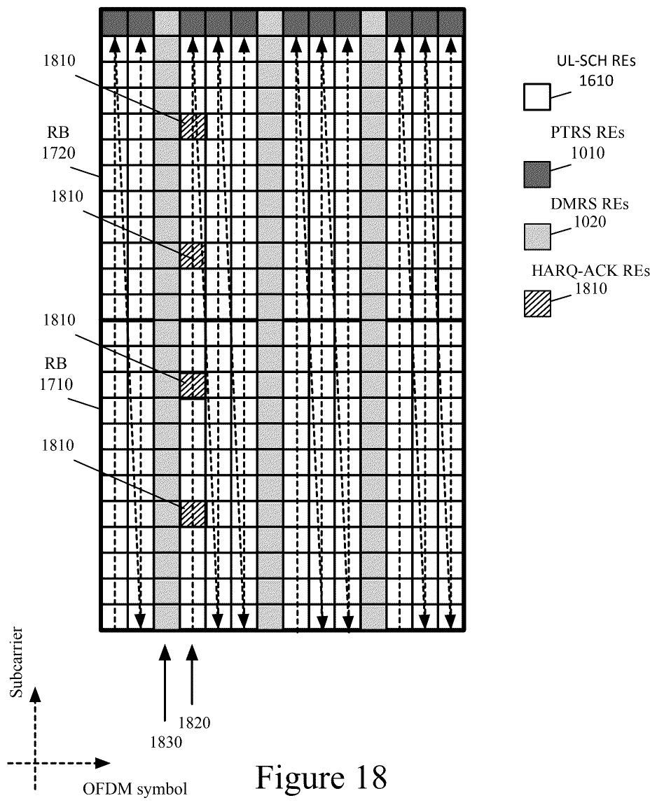

FIG. 18 is a diagram illustrating multiplexing of UL-SCH and HARQ-ACK, according to an example implementation of the present disclosure. When the UCI sequence is piggybacked on the PUSCH due to the collision of the PUCCH and PUSCH, the UCI sequence is mapped first, and the UL-SCH data sequence is mapped afterward. The HARQ-ACK sequence may be mapped in REs in an interleaved way, starting from the first OFDM symbol 1820 after the first DMRS symbol 1830. The UE avoids mapping the UL-SCH data sequence to the REs 1810 reserved for HARQ-ACK.

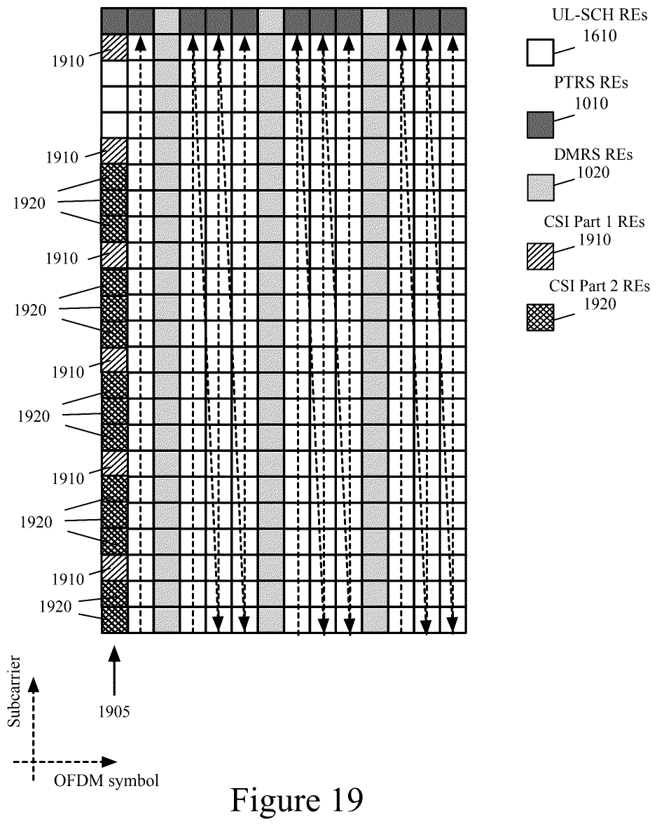

FIG. 19 is a diagram illustrating multiplexing of the UL-SCH and CSI, according to an example implementation of the present disclosure. When the CSI is piggybacked on the PUSCH, the CSI may be divided into two sequences as CSI part 1 1910 and CSI part 2 1920. The CSI part 1 sequence may be mapped in the frequency domain in an interleaved way, starting from the first OFDM symbol 1905 of the allocated PUSCH. The UE may map the CSI part 2 sequence in frequency-first time-second manner, and may avoid mapping to REs reserved for DMRS 1020, PT-RS 1010, and CSI part 1 1910. The UE may map the UL-SCH data sequence 1610 avoiding mapping to REs reserved for DMRS, PT-RS, CSI part 1, and CSI part 2.

### Technical Problem of UCI Mapping to be Solved

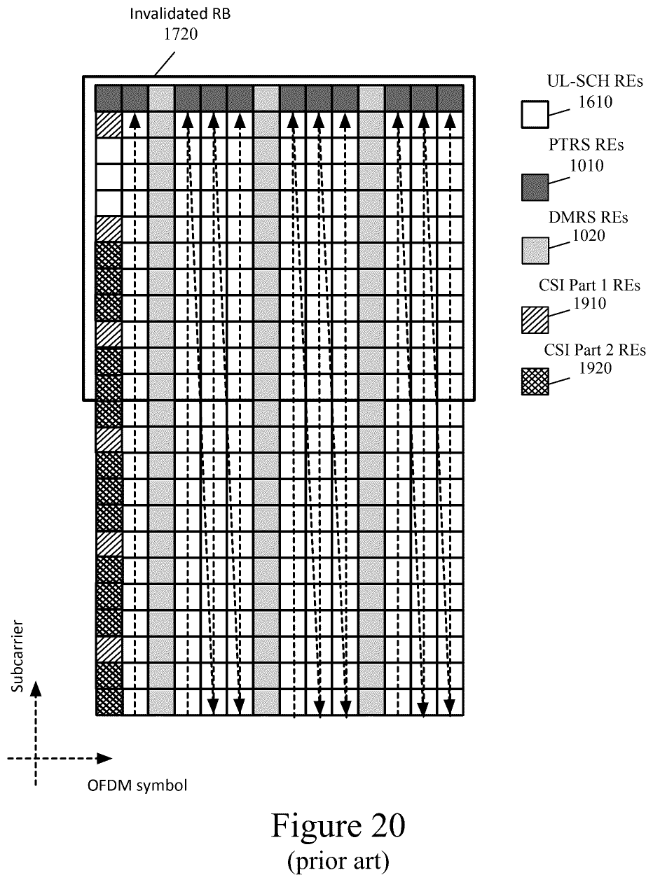

Under the current 3GPP specification, when the PUSCH is scheduled in the SBFD region, the RBs that are scheduled outside of the UL subband may be invalidated. FIG. 20 is a diagram illustrating PUSCH scheduling in SBFD symbols when a scheduled RB is invalidated due to being outside of the UL subband, according to prior art. In the example of FIG. 20, the RB 1720 is outside the UL subband and is invalidated.

In the example of FIG. 20, the PT-RS sequence 1010, a part of CSI part 1 sequence 1910, apart of CSI part 2 sequence, 1920 and apart of UL-SCH sequence 1610 may be dropped. However, dropping the PT-RS sequence and CSI part 1 sequence should be avoided at least. PT-RS may affect the overall decoding performance when phase noise is dominant in the receiver or transmitter. CSI part 1 affects decoding of CSI part 2 and UL-SCH data. This is because the number of bits for CSI part 2 is dependent on the value of the CSI part 1 (e.g., PMI bits for CSI part 2 is dependent on the Multiple-Input Multiple-Output (MIMO) rank in CSI part 1). Furthermore, UL-SCH mapping is dependent on both CSI part 1 and 2. Therefore, if the BS failed to detect CSI part 1, the BS may automatically fail to decode everything.

### Technical Solution for UCI Mapping

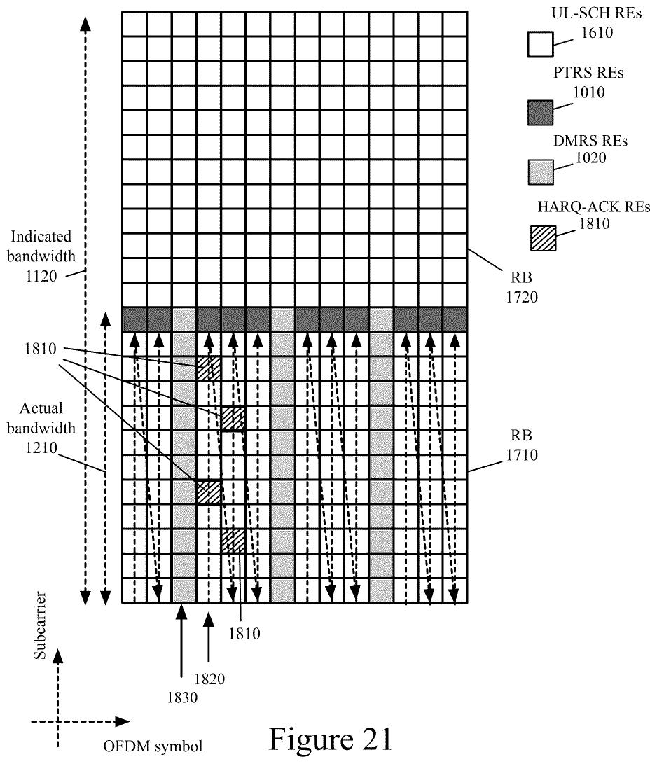

FIG. 21 is a diagram illustrating a solution which avoids the dropping of PT-RS and HARQ-ACK, when the PUSCH is scheduled in the UL subband, according to an example implementation of the present disclosure. The procedure assumes that mapping is limited to be within the actual bandwidth 1210, not within the indicated bandwidth 1120.

As shown, the HARQ-ACK coded modulation symbols may be mapped to the RE of the RBs (e.g., the RB 1710) that are in the actual bandwidth 1210. The HARQ-ACK sequence may be mapped to the REs in an interleaved way, starting from the first OFDM symbol 1820 after the first DMRS symbol 1830.

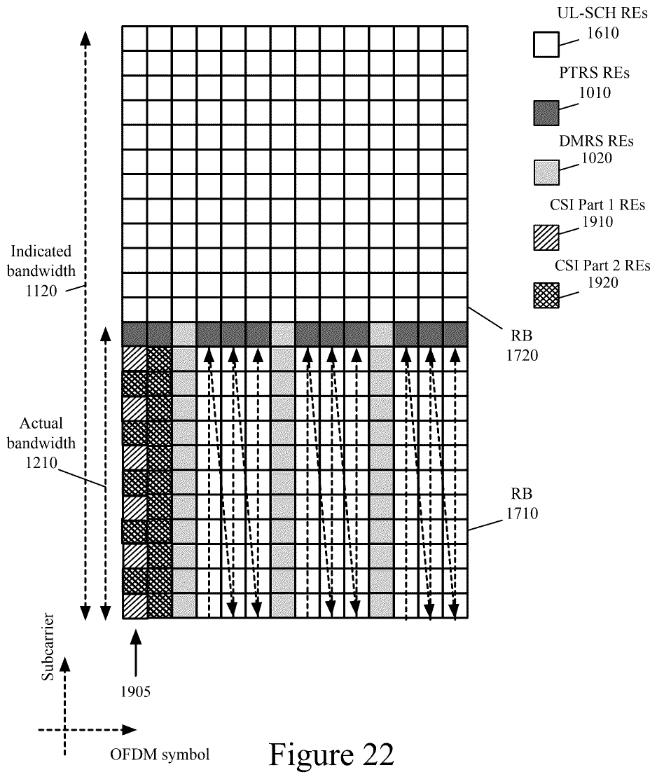

FIG. 22 is a diagram illustrating a solution which avoids the dropping of PT-RS, CSI part 1, and CSI part 2, when the PUSCH is scheduled in the UL subband, according to an example implementation of the present disclosure. The procedure assumes that mapping is limited to be within the actual bandwidth 1210, not within the indicated bandwidth 1120.

To map sequences to the PUSCH REs, the length of each sequence is necessary. In FIG. 22, the total number of REs in the indicated bandwidth may be calculated as follows:

$${M}_{RE}^{total} = {N}_{RB} {N}_{sc} {N}_{sym} = 2 * 12 * 14 = 336 REs$$

In the above equation, N_{RB} is the number RBs in the indicated bandwidth 1120, N_{sc} is the number of subcarriers per OFDM symbol, and N_{sym} is the number of OFDM symbols per RB. The number of REs available for UCI in OFDM symbol with index l is

$${M}_{sc}^{UCI} ( l ) = {M}_{sc}^{PUSCH} - {M}_{sc}^{PTRS} ( l )$$

if REs in the OFDM symbol with index l is not reserved for DMRS.

$${M}_{sc}^{PUSCH}$$

is the number of subcarriers in the indicated bandwidth.

$${M}_{sc}^{PTRS} ( l )$$

is the number of subcarriers reserved for PT-RS in the OFDM symbol with index l. In the example of FIG. 22,

$${M}_{sc}^{PTRS} ( l ) = 1$$

for l=0, 1, 3, 4, 5, 7, 8, 9, 11, 12, 13 and

$${M}_{sc}^{UCI} ( l ) = 11$$

for l=0, 1, 3, 4, 5, 7, 8, 9, 11, 12, 13. If REs in the OFDM symbol with index l is reserved for DMRS,

$${M}_{sc}^{UCI} ( l ) = 0 .$$

### Mapping of the HARQ-ACK Sequence

The number of coded modulation symbols Q′_{ACK} is determined by equation: (1)

$${Q}_{ACK}^{′} min \{ ⌈ \frac{( {O}_{ACK} + {L}_{ACK} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , ⌈ α \cdot {\sum }_{l = {l}_{0}}^{{N}_{symb , all}^{PUSCH}} {M}_{sc}^{UCI} ( l ) ⌉ \} \qquad ( 1 )$$

O_{ACK} is the number of bits after encoding in the HARQ-ACK sequence. L_{ACK} is the number of CRC bits included in the HARQ-ACK sequence.

$${β}_{offset}^{PUSCH}$$

is an offset factor provided by RRC parameters.

$${N}_{symb , all}^{PUSCH}$$

is the number of OFDM symbols allocated for the PUSCH. C_{UL-SCH} is the number of code blocks for the PUSCH. Kᵣ is the rth code block size in bits. α is a scaling factor which determines the maximum number of REs available for UCI. l₀ is the OFDM symbol index indicating the starting OFDM symbol after the first DMRS.

If the PUSCH is mapped on the SBFD symbols, the UE may determine

$${M}_{sc}^{UCI} ( l )$$

based on the actual bandwidth. For example, if the PUSCH is mapped on the SBFD symbols, the UE may determine

$${M}_{sc}^{UCI} ( l ) = {M}_{sc , actual}^{PUSCH} - {M}_{sc , actual}^{PTRS} ( l )$$

if the REs in the OFDM symbol with index l are not reserved for DMRS.

$${M}_{sc , actual}^{PUSCH}$$

is the number of subcarriers in the actual bandwidth.

$${M}_{sc , actual}^{PTRS} ( l )$$

is the number of subcarriers reserved for PT-RS based on the actual bandwidth.

If the PUSCH is mapped on the SBFD symbols, the UE may determine

$${β}_{offset}^{PUSCH}$$

based on a RRC parameter indicating the value of

$${β}_{offset}^{PUSCH}$$

for SBFD symbols, which may be different than the RRC parameter indicating the value of

$${β}_{offset}^{PUSCH}$$

for non-SBFD symbols.

If the PUSCH is mapped on the SBFD symbols, the UE may determine a based on a RRC parameter indicating the value of α for SBFD symbols, which may be different than the RRC parameter indicating the value of α for non-SBFD symbols.

### Mapping of the CSI Part 1 Sequence

The number of coded modulation symbols

$${Q}_{CSI - 1}^{′}$$

is determined by equation (2):

$${Q}_{CSI - 1}^{′} = min \{ ⌈ \frac{( {O}_{CSI - 1} + {L}_{CSI - 1} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , ⌈ α \cdot {\sum }_{l = 0}^{{N}_{symb , all}^{PUSCH} - 1} {M}_{sc}^{UCI} ( l ) ⌉ - {Q}_{ACK}^{′} \} \qquad ( 2 )$$

In the above equation, O_{CSI-1} is the number of bits after encoding in the CSI part 1 sequence. L_{CSI-1} is the number of CRC bits included in the CSI part 1 sequence.

If the PUSCH is mapped on the SBFD symbols, the UE may determine

$${M}_{sc}^{UCI} ( l )$$

based on the actual bandwidth. For example, if the PUSCH is mapped on the SBFD symbols, the UE may determine

$${M}_{sc}^{UCI} ( l ) = {M}_{sc , actual}^{PUSCH} - {M}_{sc , actual}^{PTRS} ( l )$$

if REs in the OFDM symbol with index l is not reserved for DMRS.

$${M}_{sc , actual}^{PUSCH}$$

is the number of subcarriers in the actual bandwidth.

$${M}_{sc , actual}^{PTRS} ( l )$$

is the number of subcarriers reserved for PT-RS based on the actual bandwidth.

If the PUSCH is mapped on the SBFD symbols, the UE may determine

$${β}_{offset}^{PUSCH}$$

based on a RRC parameter indicating the value of

$${β}_{offset}^{PUSCH}$$

for SBFD symbols, differently from the RRC parameter indicating the value of

$${β}_{offset}^{PUSCH}$$

for non-SBFD symbols.

If the PUSCH is mapped on the SBFD symbols, the UE may determine a based on a RRC parameter indicating the value of α for SBFD symbols, differently from the RRC parameter indicating the value of α for non-SBFD symbols.

### Mapping of the CSI Part 2 Sequence

The number of coded modulation symbols

$${Q}_{CSI - 2}^{′}$$

is determined by equation (3):

$${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , ⌈ α \cdot {\sum }_{l = 0}^{{N}_{symb , all}^{PUSCH} - 1} {M}_{sc}^{UCI} ( l ) ⌉ - {Q}_{ACK}^{′} - {Q}_{CSI - 1}^{′} \qquad ( 3 )$$

In the above equation, O_{CSI-2} is the number of bits after encoding in the CSI part 2 sequence. L_{CSI-2} is the number of CRC bits included in the CSI part 2 sequence.

If the PUSCH is mapped on the SBFD symbols, the UE may determine

$${M}_{sc}^{UCI} ( l )$$

based on the actual bandwidth. For example, if the PUSCH is mapped on the SBFD symbols, the UE may determine

$${M}_{sc}^{UCI} ( l ) = {M}_{sc , actual}^{PUSCH} - {M}_{sc , actual}^{PTRS} ( l )$$

if REs in the OFDM symbol with index l is not reserved for DMRS.

$${M}_{sc , actual}^{PUSCH}$$

is the number of subcarriers in the actual bandwidth.

$${M}_{sc , actual}^{PTRS} ( l )$$

is the number of subcarriers reserved for PT-RS based on the actual bandwidth.

If the PUSCH is mapped on the SBFD symbols, the UE may determine

$${β}_{offset}^{PUSCH}$$

based on a RRC parameter indicating the value of

$${β}_{offset}^{PUSCH}$$

for SBFD symbols, which may be different than the RRC parameter indicating the value of

$${β}_{offset}^{PUSCH}$$

for non-SBFD symbols.

If the PUSCH is mapped on the SBFD symbols, the UE may determine a based on a RRC parameter indicating the value of α for SBFD symbols, which may be different than the RRC parameter indicating the value of α for non-SBFD symbols.

In FIG. 22, the CSI part 1 sequence may be mapped in the frequency domain in an interleaved way to the REs in the RBs (e.g., the RB 1710) that are within the actual bandwidth 1210, starting from the first OFDM symbol 1905 of the allocated PUSCH. The UE may map the CSI part 2 sequence in frequency-first time-second manner, and may avoid mapping to REs reserved for DMRS 1020, PT-RS 1010, and CSI part 1 1910. The UE may map the UL-SCH data sequence 1610 avoiding mapping to REs reserved for DMRS, PT-RS, CSI part 1, and CSI part 2. It should be noted that the symbols associated with the UCI, HARQ-ACK, CSI part 1, CSI part 2, and UL-SCH are coded modulation symbols, which are symbols that are results of channel coding. In contrast, the symbols associated with the OFDM, PT-RS, and RMRS are not coded modulation symbols.

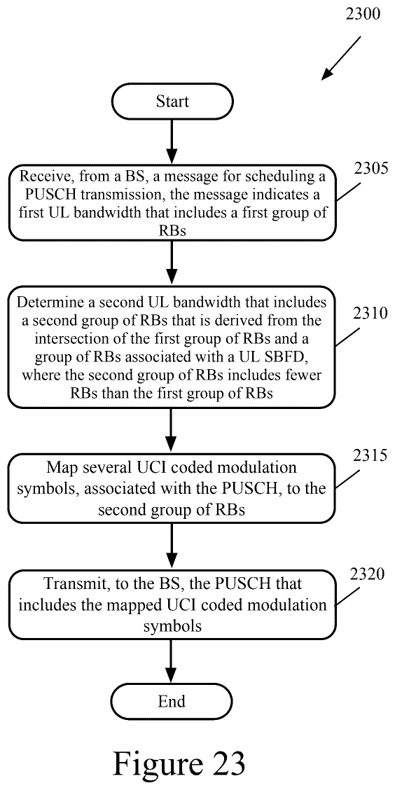

FIG. 23 is a flowchart illustrating an example method/process 2300 performed by a UE to map UCI coded modulation symbols to REs, according to an example implementation of the present disclosure. The process 2300 may be performed by at least one processor of a UE 101A-101C, shown in FIG. 1.

The process 2300 may receive (at block 2305), from a BS, a message for scheduling a PUSCH transmission. The message may indicate a first UL bandwidth that includes a first group of RBs. For example, the first UL bandwidth may be the indicated bandwidth 1120 shown in FIGS. 21 and 22. The process 2300, in some embodiments, may receive a DCI message that may include an FDRA filed. The FDRA field may include several bits. Each bit may indicate whether a corresponding RB group is allocated for the PUSCH. The process 2300 may receive the DCI in a PDCCH.

The process 2300 may determine (at block 2310) a second UL bandwidth that includes a second group of RBs that is derived from the intersection of the first group of RBs and a group of RBs associated with a UL SBFD. The second group of RBs may include fewer RBs than the first group of RBs. For example, the process 2300 may determine the actual bandwidth 1210 shown in FIGS. 21 and 22 as the intersection of the RBs in the UL subband and the RBs in the indicated bandwidth 1120.

The process 2300 may map (at block 2315) several UCI coded modulation symbols, associated with the PUSCH, to the second group of RBs. The UCI coded modulation symbols, in some embodiments, may include HARQ-ACK coded modulation symbols, each RB may include several OFDM symbols, and each OFDM symbol may include several REs. The mapping of the UCI coded modulation symbols to an RB in the second group of RBs, in these embodiments, may include the followings. The process 2300 may map several DMRS symbols, arranged in a frequency-first time-second sequence, to the REs of several OFDM symbols of the RB. The process 2300 may identify an OFDM symbol (e.g., the OFDM symbol 1820 shown in FIG. 21) that is after a first DMRS symbol (e.g., the DMRS symbol 1830) in the frequency-first time-second sequence. The process 2300 may start with the identified OFDM and map the HARQ-ACK coded modulation symbols, arranged in the frequency-first time-second sequence, to several REs. For example, the process 2300 may map the HARQ-ACK coded modulation symbols to several REs 1810 of the RB 1710, as shown in FIG. 21.

The UCI coded modulation symbols, in some embodiments, may include CSI part 1 and CSI part 2 coded modulation symbols, each RB may include several OFDM symbols, and each OFDM symbol may include several REs. The mapping of the UCI coded modulation symbols to an RB in the second group of RBs, in these embodiments, may include the followings. The process 2300 may start with a first OFDM symbol in the RB (e.g., the OFDM symbol 1905 of the RB 1710), and may map the CSI part 1 coded modulation symbols, arranged in a frequency-first time-second sequence, to REs of the RB. The process 2300 may start with the first OFDM symbol in the RB (e.g., the OFDM symbol 1905 of the RB 1710), and may map the CSI part 2 symbols, arranged in a frequency-first time-second sequence, to several REs that are not mapped to the CSI part 1 coded modulation symbols.

The process 2300 may transmit (at block 2320), to the BS, the PUSCH that includes the mapped UCI coded modulation symbols. The process 2300 may then end.

The various foregoing example embodiments and modes may be utilized in conjunction with one another, for example, in combination with one another.

Each of a program running on the base station device 103 and the terminal device 101 according to an aspect of the present invention may be a program that controls a Central Processing Unit (CPU) and the like, such that the program causes a computer to operate in such a manner as to realize the functions of the above-described embodiment according to the present invention. The information handled in these devices is transitorily stored in a Random-Access-Memory (RAM) while being processed. Thereafter, the information is stored in various types of Read-Only-Memory (ROM) such as a Flash ROM and a Hard-Disk-Drive (HDD), and when necessary, is read by the CPU to be modified or rewritten.

Note that the terminal device 101 and the base station device 103 according to the above-described embodiment may be partially achieved by a computer. In this case, this configuration may be realized by recording a program for realizing such control functions on a computer-readable recording medium and causing a computer system to read the program recorded on the recording medium for execution.

Note that it is assumed that the “computer system” mentioned here refers to a computer system built into the terminal device 101 or the base station device 103, and the computer system includes an OS and hardware components such as a peripheral device. Furthermore, the “computer-readable recording medium” refers to a portable medium such as a flexible disk, a magneto-optical disk, a ROM, a CD-ROM, and the like, and a storage device built into the computer system such as a hard disk.

Moreover, the “computer-readable recording medium” may include a medium that dynamically retains a program for a short period of time, such as a communication line that is used to transmit the program over a network such as the Internet or over a communication line such as a telephone line, and may also include a medium that retains a program for a fixed period of time, such as a volatile memory within the computer system for functioning as a server or a client in such a case. Furthermore, the program may be configured to realize some of the functions described above, and also may be configured to be capable of realizing the functions described above in combination with a program already recorded in the computer system.

Furthermore, the base station device 103 according to the above-described embodiment may be achieved as an aggregation (a device group) including multiple devices. Each of the devices configuring such a device group may include some or all of the functions or the functional blocks of the base station device 103 according to the above-described embodiment. The device group may include each general function or each functional block of the base station device 103. Furthermore, the terminal device 101 according to the above-described embodiment can also communicate with the base station device as the aggregation.

Furthermore, the base station device 103 according to the above-described embodiment may serve as an Evolved Universal Terrestrial Radio Access Network (E-UTRAN) and/or NG-RAN (Next Gen RAN, NR-RAN, 6G-RAN). Furthermore, the base station device 103 according to the above-described embodiment may have some or all of the functions of a node higher than an eNodeB or the gNB.

Furthermore, some or all portions of each of the terminal device 101 and the base station device 103 according to the above-described embodiment may be typically achieved as an LSI which is an integrated circuit or may be achieved as a chip set. The functional blocks of each of the terminal device 101 and the base station device 103 may be individually achieved as a chip, or some or all of the functional blocks may be integrated into a chip. Furthermore, a circuit integration technique is not limited to the LSI, and may be realized with a dedicated circuit or a general-purpose processor. Furthermore, in a case that with advances in semiconductor technology, a circuit integration technology with which an LSI is replaced appears, it is also possible to use an integrated circuit based on the technology.

Furthermore, according to the above-described embodiment, the terminal device 101 has been described as an example of a communication device, but the present invention is not limited to such a terminal device, and is applicable to a terminal device or a communication device of a fixed-type or a stationary-type electronic device installed indoors or outdoors, for example, such as an Audio-Video (AV) device, a kitchen device, a cleaning or washing machine, an air-conditioning device, office equipment, a vending machine, and other household devices.

The embodiments of the present invention have been described in detail above referring to the drawings, but the specific configuration is not limited to the embodiments and includes, for example, an amendment to a design that falls within the scope that does not depart from the gist of the present invention. Furthermore, various modifications are possible within the scope of one aspect of the present invention defined by claims, and embodiments that are made by suitably combining technical means disclosed according to the different embodiments are also included in the technical scope of the present invention. Furthermore, a configuration in which constituent elements, described in the respective embodiments and having mutually the same effects, are substituted for one another is also included in the technical scope of the present invention.

What is claimed is:

1. A user equipment (UE), comprising:
one or more non-transitory computer-readable media storing one or more computer-executable instructions; and
at least one processor coupled to the one or more non-transitory computer-readable media, and configured to execute the one or more computer-executable instructions to cause the UE to:
receive, from a base station (BS), a message for scheduling a physical uplink (UL) shared channel (PUSCH) transmission, the message indicating a first UL bandwidth comprising a first plurality of resource blocks (RBs);
determine a second UL bandwidth comprising a second plurality of RBs that is derived from an intersection of the first plurality of RBs and a plurality of RBs associated with a UL subband full duplex (SBFD), wherein the second plurality of RBs comprises fewer RBs than the first plurality of RBs;
map a plurality of phase-tracking reference signals (PT-RSs), associated with the PUSCH, to the second plurality of RBs; and
transmit, to the BS, the PUSCH that includes the mapped plurality of PT-RSs.

2. The UE of claim 1, wherein:
the plurality of PT-RSs comprises a plurality of PT-RS groups,
each PT-RS group comprises a plurality of PT-RS samples,
each RB comprises a plurality of subcarriers in frequency domain, and
wherein mapping the plurality of PT-RSs to the second plurality of RBs comprises:
receiving, from the BS, a number of PT-RS groups and a number of samples per PT-RS group,
determining a plurality of subcarrier indexes based on the number of PT-RS groups and the number of samples per PT-RS group, and
mapping the plurality of PT-RSs to the second plurality of RBs starting at the determined plurality of subcarrier indexes.

3. The UE of claim 2, wherein the plurality of subcarrier indexes is determined as a function of a total number of subcarriers in the second UL bandwidth.

4. The UE of claim 2, wherein the number of PT-RS groups and the number of samples per PT-RS group are received, from the BS, in radio resource control (RRC) signaling.

5. The UE of claim 1, wherein:
the message received from the BS comprises downlink control information (DCI), and
the first UL bandwidth is indicated by a frequency domain resource allocation (FDRA) field in the DCI.

6. The UE of claim 5, wherein:
the FDRA field comprises a plurality of bits,
each bit indicates whether a corresponding RB group is allocated for the PUSCH, and
each RB group comprises a plurality of RBs.

7. The UE of claim 6, wherein the DCI is received, from the BS, in a physical downlink control channel (PDCCH).

8. A user equipment (UE), comprising:
one or more non-transitory computer-readable media storing one or more computer-executable instructions; and
at least one processor coupled to the one or more non-transitory computer-readable media, and configured to execute the one or more computer-executable instructions to cause the UE to:
receive, from a base station (BS), a message for scheduling a physical uplink (UL) shared channel (PUSCH) transmission, the message indicating a first UL bandwidth comprising a first plurality of resource blocks (RBs);
determine a second UL bandwidth comprising a second plurality of RBs that is derived from an intersection of the first plurality of RBs and a plurality of RBs associated with a UL subband full duplex (SBFD), wherein the second plurality of RBs comprises fewer RBs than the first plurality of RBs;
map a plurality of uplink control information (UCI) coded modulation symbols, associated with the PUSCH, to an RB in the second plurality of RBs; and
transmit, to the BS, the PUSCH that includes the mapped plurality of UCI coded modulation symbols.

9. The UE of claim 8, wherein the plurality of UCI coded modulation symbols comprises a plurality of hybrid automatic repeat request acknowledgement (HARQ-ACK) coded modulation symbols.

10. The UE of claim 9, wherein:
each RB comprises a plurality of OFDM symbols,
each OFDM symbol comprises a plurality of resource elements (REs), and
wherein mapping the plurality of UCI coded modulation symbols to the RB in the second plurality of RBs comprises:
mapping a plurality of demodulation reference signal (DMRS) symbols, arranged in a frequency-first time-second sequence, to the plurality of REs of a plurality of OFDM symbols of the RB,
identifying an OFDM symbol that is after a first DMRS symbol in the frequency-first time-second sequence, and
starting with the identified OFDM, mapping the plurality of HARQ-ACK coded modulation symbols, arranged in the frequency-first time-second sequence, to a plurality of REs.

11. The UE of claim 8, wherein the plurality of UCI coded modulation symbols comprises a plurality of channel state information (CSI) part 1 coded modulation symbols, and a plurality of CSI part 2 coded modulation symbols.

12. The UE of claim 11, wherein:
each RB comprises a plurality of OFDM symbols,
each OFDM symbol comprises a plurality of resource elements (REs), and
wherein mapping the plurality of UCI coded modulation symbols to the RB in the second plurality of RBs comprises:
starting with a first OFDM symbol in the RB, mapping the plurality of CSI part 1 coded modulation symbols, arranged in a frequency-first time-second sequence, to a plurality of REs, and
starting with the first OFDM symbol in the RB, mapping the plurality of CSI part 2 coded modulation symbols, arranged in a frequency-first time-second sequence, to a plurality of REs that is not mapped to the plurality of CSI part 1 coded modulation symbols.

13. The UE of claim 8, wherein:
the message received from the BS comprises downlink control information (DCI),
the first UL bandwidth is indicated by a frequency domain resource allocation (FDRA) field in the DCI, and
the DCI is received from the BS in a physical downlink control channel (PDCCH).

14. The UE of claim 13, wherein:
the FDRA field comprises a plurality of bits,
each bit indicates whether a corresponding RB group is allocated for the PUSCH, and
each RB group comprises a plurality of RBs.

15. A method, comprising:
receiving, by a user equipment (UE), from a base station (BS), a message for scheduling a physical uplink (UL) shared channel (PUSCH) transmission, the message indicating a first UL bandwidth comprising a first plurality of resource blocks (RBs);
determining a second UL bandwidth comprising a second plurality of RBs that is derived from an intersection of the first plurality of RBs and a plurality of RBs associated with a UL subband full duplex (SBFD), wherein the second plurality of RBs comprises fewer RBs than the first plurality of RBs;
mapping a plurality of phase-tracking reference signals (PT-RSs), associated with the PUSCH, to the second plurality of RBs; and
transmitting, to the BS, the PUSCH that includes the mapped plurality of PT-RSs.
